(19) United States
(12) Patent Application Publication
(10) Pub. No.: US 2023/0373524 A1
(43) Pub. Date: Nov. 23, 2023

(54) AUTOMATIC DRIVING DEVICE AND RADAR DEVICE

(71) Applicant: Mitsubishi Electric Corporation, Tokyo (JP)

(72) Inventors: Yuichi MORITA, Tokyo (JP); Yuichi GODA, Tokyo (JP)

(73) Assignee: Mitsubishi Electric Corporation, Tokyo (JP)

(21) Appl. No.: 18/192,836

(22) Filed: Mar. 30, 2023

(30) Foreign Application Priority Data
May 19, 2022 (JP) 2022-082370

(51) Int. Cl. B60W 60/00; B60W 30/14; G01S 13/931; G01S 13/28

(52) U.S. Cl. CPC B60W 60/0011; B60W 60/0015; B60W 30/146; G01S 13/931; G01S 13/282; B60W 2420/52; B60W 2554/20; B60W 2554/80; G01S 2013/932

(57) ABSTRACT

Provided is an automatic driving device capable of suppressing a decrease in accuracy of object detection by a radar device. A vehicle controller controls driving of a vehicle based on information received from a radar device. Driving modes of the vehicle to be used by the controller include a separation mode. The controller has a control target monitoring area set therefor. The area is an area on a front side in a traveling direction of the vehicle. The controller controls the driving of the vehicle in the separation mode so that an object assumed to be present in the area and a detected object that is different from the object are separately detected by the radar device. The detected object is at least one of a structure outside the vehicle or an indirect wave from the object via the structure.

### BACKGROUND OF THE INVENTION

### 1. Field of the Invention

This disclosure relates to an automatic driving device and a radar device.

### 2. Description of the Related Art

According to the related art (for example, Japanese Patent Application Laid-open No. 2019-206339), when a driver of a vehicle falls into a situation in which the driver has difficulty in driving, a travel control apparatus automatically stops the vehicle in a pull-over area on behalf of the driver based on information received from a camera and a radar.

For radars, roadside objects such as guardrails are highly reflective objects, while humans are low reflective objects. Therefore, for example, when a vehicle is to be pulled over to a pull-over area, it may be difficult for a radar to detect a human present near a roadside object. Thus, there is a fear in that such a related-art travel control apparatus as described above may cause a decrease in accuracy of object detection by a radar.

### SUMMARY OF THE INVENTION

This disclosure has been made in order to solve the above-mentioned problem, and has an object to provide an automatic driving device and a radar device that suppress a decrease in accuracy of object detection by a radar device.

According to at least one embodiment of this disclosure, there is provided an automatic driving device including a vehicle controller configured to control driving of a vehicle based on information received from a radar device mounted to the vehicle, wherein driving modes of the vehicle to be used by the vehicle controller include a separation mode, wherein the vehicle controller has a control target monitoring area set therefor, the control target monitoring area being an area on a front side in a traveling direction of the vehicle, wherein the vehicle controller is configured to control the driving of the vehicle in the separation mode so that an object assumed to be present in the control target monitoring area and a detected object that is different from the object are separately detected by the radar device, and wherein the detected object is at least one of a structure outside the vehicle or an indirect wave from the object via the structure.

According to the automatic driving device and the radar device of the at least one embodiment of this disclosure, it is possible to suppress a decrease in accuracy of object detection by the radar device.

### BRIEF DESCRIPTION OF THE DRAWINGS

FIG. 1 is a block diagram for illustrating a configuration of an automatic driving device according to a first embodiment of this disclosure.

FIG. 2 is a configuration diagram for illustrating a radar device of FIG. 1 partially as blocks.

FIG. 3 is a schematic graph for showing an example of a modulation pattern in the radar device of FIG. 2.

FIG. 4 is a flow chart for illustrating a target object detection routine to be executed by a radar controller of FIG. 2.

FIG. 5 is a schematic view for illustrating a positional relationship among a vehicle, a peripheral structure, and a target object.

FIG. 6 is a schematic graph for showing an example of a two-dimensional power spectrum obtained when the radar device is used to detect two objects having mutually different distances from the radar device.

FIG. 7 is a graph for showing a power spectrum in a specific relative velocity bin of FIG. 6.

FIG. 8 is a schematic view for illustrating a relationship between a relative velocity between the vehicle and the peripheral structure and a relative velocity between the vehicle and the target object.

FIG. 9 is a schematic graph for showing an example of a two-dimensional power spectrum obtained when the radar device is used to detect two objects having mutually different relative velocities with respect to the vehicle.

FIG. 10 is a graph for showing a power spectrum in a specific range bin of FIG. 9.

FIG. 11 is a flow chart for illustrating a driving mode selection routine to be executed by a driving support controller of FIG. 1.

FIG. 12 is a flow chart for illustrating a first pull-over mode routine of Step S205 of FIG. 11.

FIG. 13 is a flow chart for illustrating a second pull-over mode routine of Step S206 of FIG. 11.

FIG. 14 is a flow chart for illustrating a pull-over-path-and-vehicle-speed-plan calculation routine of Step S406 of FIG. 13.

FIG. 15 is a flow chart for illustrating a pull-over-path-and-vehicle-speed-plan limiting value calculation routine of Step S502 of FIG. 14.

FIG. 16 is a schematic view for illustrating a control target monitoring area.

FIG. 17 is a schematic diagram for illustrating an example of a flow after an object is detected by the radar device until the vehicle is stopped.

FIG. 18 is a flow chart for illustrating a separable lateral position table creation routine of Step S602 of FIG. 15.

FIG. 19 is a view for illustrating a method of calculating a first lateral position limiting value when the peripheral structure is linearly arranged.

FIG. 20 is a table for showing an example of a separable lateral position table obtained when the peripheral structure is linearly arranged.

FIG. 21 is a view for illustrating a method of calculating a second lateral position limiting value when the peripheral structure is linearly arranged.

FIG. 22 is a schematic view for illustrating a travelable area of the vehicle to be used when the vehicle travels straight in a case in which the peripheral structure is linearly arranged.

FIG. 23 is a schematic view for illustrating the travelable area of the vehicle to be used when the vehicle travels while approaching the peripheral structure in the case in which the peripheral structure is linearly arranged.

FIG. 24 is a schematic view for illustrating the travelable area of the vehicle to be used when the vehicle travels straight at a low speed in the case in which the peripheral structure is linearly arranged.

FIG. 25 is a view for illustrating an example of how to review a pull-over path and how to review a vehicle speed plan at a time of initial path generation when the peripheral structure is linearly arranged.

FIG. 26 is a view for illustrating an example of how to review the pull-over path and how to review the vehicle speed plan in a first path review plan when the peripheral structure is linearly arranged.

FIG. 27 is a view for illustrating an example of how to review the pull-over path and how to review the vehicle speed plan in a second path review plan when the peripheral structure is linearly arranged.

FIG. 28 is a flow chart for illustrating the pull-over-path-and-vehicle-speed-plan limiting value calculation routine in consideration of radar performance of Step S502 of FIG. 14.

FIG. 29 is a flow chart for illustrating a separability table generation routine of Step S802 of FIG. 28.

FIG. 30 is a view for illustrating a separability determination method for a range direction to be performed when the peripheral structure is arranged in a random shape.

FIG. 31 is a view for illustrating a separability determination method for a relative velocity direction to be performed when the peripheral structure is arranged in a random shape.

FIG. 32 is a schematic view for illustrating a first example of the travelable area of the vehicle to be used when the peripheral structure is arranged in a random shape.

FIG. 33 is a schematic view for illustrating a second example of the travelable area of the vehicle to be used when the peripheral structure is arranged in a random shape.

FIG. 34 is a schematic view for illustrating a third example of the travelable area of the vehicle to be used when the peripheral structure is arranged in a random shape.

FIG. 35 is a schematic view for illustrating an example of a traveling area of the vehicle to be used when the vehicle travels straight in a case in which the traveling area is limited when the peripheral structure is arranged in a random shape.

FIG. 36 is a schematic view for illustrating an example of the traveling area of the vehicle to be used when the vehicle travels while approaching the peripheral structure in the case in which the traveling area is limited when the peripheral structure is arranged in a random shape.

FIG. 37 is a flow chart for illustrating a separability table generation routine in a second embodiment of this disclosure.

FIG. 38 is a view for illustrating a determination method for separability between a direct wave and an indirect wave to be performed when the peripheral structure is arranged in a random shape.

FIG. 39 is a configuration diagram for illustrating a first example of a processing circuit that implements functions of the automatic driving device according to each of the first embodiment and the second embodiment.

FIG. 40 is a configuration diagram for illustrating a second example of the processing circuit that implements the functions of the automatic driving device according to each of the first embodiment and the second embodiment.

### DESCRIPTION OF THE EMBODIMENTS

Now, embodiments of this disclosure are described with reference to the drawings. In the following description, like components are denoted by like reference numerals.

### First Embodiment

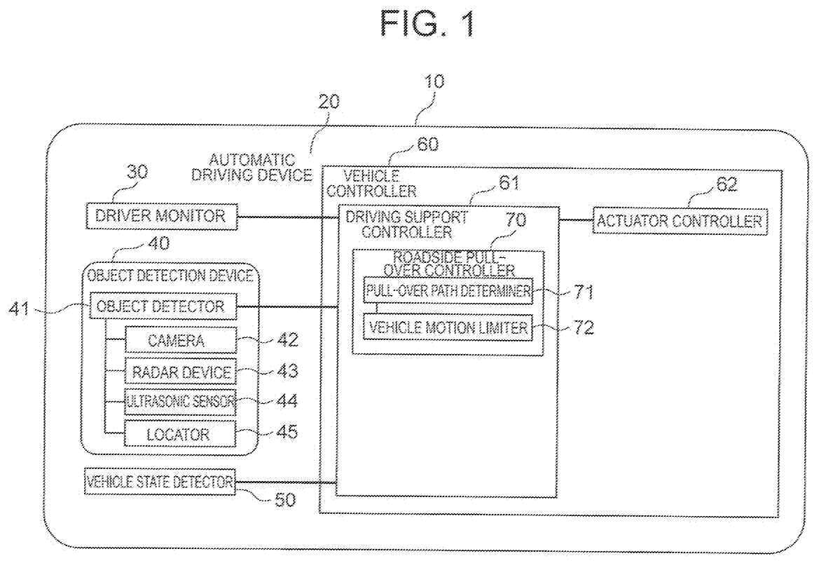

FIG. 1 is a block diagram for illustrating a configuration of an automatic driving device according to a first embodiment of this disclosure. An automatic driving device 20 is provided to a vehicle 10. The automatic driving device 20 includes a driver monitor 30, an object detection device 40, a vehicle state detector 50, and a vehicle controller 60.

The driver monitor 30 monitors a state of a driver of the vehicle 10, and determines whether or not the driver can continue to drive. The driver monitor 30 monitors, for example, a heart rate of the driver, an eye movement of the driver, a driving behavior of the driver.

The object detection device 40 acquires obstacle information and road information. The obstacle information is information relating to a position of an obstacle present in a periphery of the vehicle 10. The road information is information including a change of a road in a traveling direction of the vehicle 10.

The object detection device 40 includes an object detector 41, a camera 42 serving as a sensor, a radar device 43, an ultrasonic sensor 44 and a locator 45.

The object detector 41 acquires pieces of information detected by the camera 42, the radar device 43, the ultrasonic sensor 44, and the locator 45, and integrates the acquired pieces of information to output the integrated information to the vehicle controller 60. The camera 42 includes a camera for photographing a front side in the traveling direction of the vehicle 10 and a camera for photographing the periphery of the vehicle 10.

The radar device 43 is mounted to a front portion of the vehicle 10. The radar device 43 emits electromagnetic waves toward the front side in the traveling direction of the vehicle 10, and detects reflected waves thereof, to thereby output a relative distance, a relative velocity, and an angle of an obstacle with respect to the vehicle 10. The radar device 43 may be provided not only to the front portion of the vehicle 10 but also to each of left and right rear portions of the vehicle 10 to output a relative distance, a relative velocity, and an angle of an obstacle of an object behind the vehicle 10 with respect thereto.

The ultrasonic sensor 44 emits ultrasonic waves, and detects reflected waves thereof, to thereby output the relative distance of the obstacle with respect to the vehicle 10. For example, the object detector 41 integrates information relating to the object detected by the camera 42 and information relating to the object detected by the radar device 43, to thereby generate more reliable information.

The object detector 41 also integrates information received from a sensor for monitoring the front side of the vehicle 10 and information received from a sensor for monitoring the periphery of the vehicle 10 to generate information relating to the entire periphery of the vehicle 10. Further, the object detector 41 determines in which lane another vehicle in the periphery of the vehicle 10 is present based on the information on white lines detected by the camera 42. Such integration of pieces of information received from a plurality of sensors to generate more reliable information is also called “sensor fusion.”

The vehicle state detector 50 acquires, as vehicle state information, information including a vehicle speed being a speed of the vehicle 10, an acceleration of the vehicle 10, an azimuth angle of the vehicle 10, and an angular velocity of the vehicle 10. The vehicle state detector 50 includes a steering angle sensor, a steering torque sensor, a yaw rate sensor, a speed sensor, and an acceleration sensor.

The vehicle controller 60 controls driving of the vehicle 10 based on information received from the radar device 43. Driving modes of the vehicle 10 to be selected by the vehicle controller 60 include a separation mode. A control target monitoring area is set for the vehicle controller 60. The control target monitoring area is an area on the front side in the traveling direction of the vehicle 10. In the separation mode, the vehicle controller 60 controls the driving of the vehicle 10 so that a peripheral structure serving as a structure and an object assumed to be present in the control target monitoring area are separately detected by the radar device 43. The peripheral structure is a detected object that is different from the object assumed to be present in the control target monitoring area.

The peripheral structure is a structure outside the vehicle 10. For example, the peripheral structure is a stationary object such as a guardrail. The peripheral structure is detected by the object detection device 40. For example, the peripheral structure may be detected based on the information received from the radar device 43, or may be detected based on positional information on the vehicle 10 and map information that are received from the locator 45.

The “separation” as used herein represents that the radar device 43 can correctly detect two objects as separate objects. As a plurality of control modes, the vehicle controller 60 has a manual driving compatible mode and an automatic driving compatible mode. The manual driving compatible mode is a mode to be selected when a driving entity of the vehicle 10 is a driver. The automatic driving compatible mode is a mode to be selected when the driving entity of the vehicle 10 is the vehicle controller 60.

The vehicle controller 60 includes a driving support controller 61 and an actuator controller 62. The driving support controller 61 is also called “advanced driver-assistance systems electronic control unit (ADAS-ECU).” The driving support controller 61 includes a roadside pull-over controller 70. The roadside pull-over controller 70 executes control for automatically stopping the vehicle 10 on the roadside when the driver of the vehicle 10 has difficulty in driving in the automatic driving compatible mode.

The roadside pull-over controller 70 includes a pull-over path determiner 71 and a vehicle motion limiter 72. The pull-over path determiner 71 determines a travel path and a future vehicle speed of the vehicle 10 based on physical restrictions, road signs, ride comfort, positional relationships of the vehicle 10 with respect to structures in the periphery of the vehicle 10, and positional relationships between the vehicle 10 and other vehicles in the periphery of the vehicle 10. The physical restrictions include the vehicle speed, an acceleration and a deceleration of the vehicle 10, and a steering angle.

The vehicle motion limiter 72 limits motion of the vehicle 10 based on a resolution of the radar device 43, a position of the vehicle 10, the vehicle speed, and the azimuth angle serving as the traveling direction of the vehicle 10. The resolution of the radar device 43 includes a range resolution and a relative velocity resolution.

The pull-over path determiner 71 determines the travel path and the vehicle speed of the vehicle 10 based on parameters regarding the motion of the vehicle 10 determined by the vehicle motion limiter 72, that is, within a limit range set by the vehicle motion limiter 72.

The actuator controller 62 controls a plurality of actuators of the vehicle 10 so that pull-over control of the vehicle 10 is achieved. The actuator controller 62 includes, for example, an electric power steering ECU, a power train ECU, and a brake ECU.

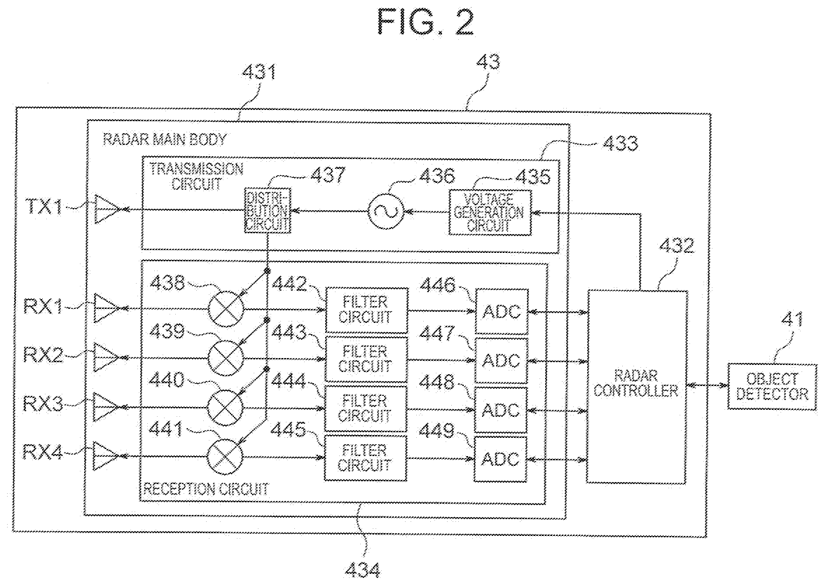

FIG. 2 is a configuration diagram for illustrating the radar device 43 of FIG. 1 partially as blocks. The radar device 43 includes a radar main body 431 and a radar controller 432. The radar main body 431 includes a transmission circuit 433, a reception circuit 434, a transmission antenna Tx1, and reception antennas Rx1, Rx2, Rx3, and Rx4.

The transmission circuit 433 includes a voltage generation circuit 435, a voltage-controlled oscillator 436, and a distribution circuit 437. The reception circuit 434 includes mixers 438 to 441, filter circuits 442 to 445, and analog-to-digital converters (ADCs) 446 to 449.

The voltage generation circuit 435 generates a voltage waveform in accordance with a control timing of the radar controller 432. The voltage-controlled oscillator 436 oscillates a transmission signal based on the voltage waveform generated by the voltage generation circuit 435. The distribution circuit 437 amplifies the oscillated transmission signal. The distribution circuit 437 outputs the amplified transmission signal to the transmission antenna Tx1 and to the mixers 438 to 441 in the reception circuit 434 as well.

An electromagnetic wave serving as the transmission signal radiated from the transmission antenna Tx1 is reflected by a target object outside the vehicle 10. Reflected electromagnetic waves are received by the reception antennas Rx1 to Rx4. The electromagnetic waves received by the reception antennas Rx1 to Rx4 are input to the reception circuit 434 as reception signals. The reception signal received from the reception antenna Rx1 is input to the mixer 438. The reception signal received from the reception antenna Rx2 is input to the mixer 439. The reception signal received from the reception antenna Rx3 is input to the is input to the mixer 440. The reception signal received from the reception antenna Rx4 is input to the mixer 441.

The mixer 438 mixes the reception signal received by the reception antenna Rx1 and the transmission signal received from the distribution circuit 437 to output a beat signal being a mixed signal to the filter circuit 442. The mixer 439 mixes the reception signal received by the reception antenna Rx2 and the transmission signal received from the distribution circuit 437 to output a beat signal to the filter circuit 443. The mixer 440 mixes the reception signal received by the reception antenna Rx3 and the transmission signal received from the distribution circuit 437 to output a beat signal to the filter circuit 444. The mixer 441 mixes the reception signal received by the reception antenna Rx4 and the transmission signal received from the distribution circuit 437 to output a beat signal to the filter circuit 445.

The filter circuits 442 to 445 each include a band-pass filter and an amplifier circuit. The band-pass filter is a filter for extracting a signal in a specific frequency band. The amplifier circuit is a circuit for amplifying the signal extracted by the band-pass filter.

The filter circuit 442 extracts a signal in a specific frequency band from the beat signal received from the mixer 438 and amplifies the extracted signal to output the amplified signal to the ADC 446. The filter circuit 443 extracts a signal in a specific frequency band from the beat signal received from the mixer 439 and amplifies the extracted signal to output the amplified signal to the ADC 447. The filter circuit 444 extracts a signal in a specific frequency band from the beat signal received from the mixer 440 and amplifies the extracted signal to output the amplified signal to the ADC 448. The filter circuit 445 extracts a signal in a specific frequency band from the beat signal received from the mixer 441 and amplifies the extracted signal to output the amplified signal to the ADC 449.

The ADC 446 converts the analog voltage signal received from the filter circuit 442 into digital voltage data in accordance with the control timing of the radar controller 432 to output the digital voltage data to the radar controller 432. The ADC 447 converts the analog voltage signal received from the filter circuit 443 into digital voltage data in accordance with the control timing of the radar controller 432 to output the digital voltage data to the radar controller 432. The ADC 448 converts the analog voltage signal received from the filter circuit 444 into digital voltage data in accordance with the control timing of the radar controller 432 to output the digital voltage data to the radar controller 432. The ADC 449 converts the analog voltage signal received from the filter circuit 445 into digital voltage data in accordance with the control timing of the radar controller 432 to output the digital voltage data to the radar controller 432.

The pieces of digital voltage data input to the radar controller 432 are stored in a memory (not shown) included in the radar controller 432.

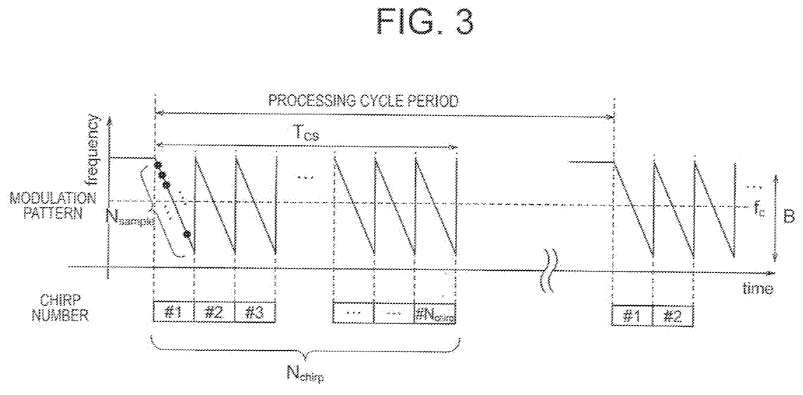

FIG. 3 is a schematic graph for showing an example of a modulation pattern in the radar device 43 of FIG. 2. A fast chirp modulation (FCM) method is a modulation method of repeatedly changing a frequency of a carrier wave at a constant rate of change. A single drop in frequency is called “chirp.” A series of chirps repeatedly transmitted is called “chirp sequence.” In FIG. 3, the number of chirps per processing cycle period is N_{chirp}. The processing cycle period is a repetition interval for the chirp sequence. One processing cycle period is, for example, 50 ms.

The radar controller 432 calculates a distance between the radar device 43 and a target object and a relative velocity between the radar device 43 and the target object from the digital voltage data corresponding to four channels. A principle of calculating a distance and a relative velocity in the FCM method is publicly known, and is described in, for example, Japanese Patent Application Laid-open No. 2016-3873.

The number of samples per chirp is represented by Nₛₐₘₚₗₑ, the number of fast Fourier transform (FFT) points in a range direction is represented by N_{RFFT}, and the number of FFT points in a relative velocity direction is represented by N_{VFFT}. It is assumed that the number Nₛₐₘₚₗₑ of samples per chirp and the number N_{RFFT} of FFT points in the range direction are equal to each other and the number N_{chirp} of chirps and the number N_{VFFT} of FFT points in the relative velocity direction are equal to each other. In this case, as a waveform obtained after FFT processing in the range direction and FFT processing in the relative velocity direction, a two-dimensional power spectrum having N_{RFFT}/2 bins in the range direction and N_{VFFT} bins in the relative velocity direction is obtained. The range direction means a chirp direction, and the relative velocity direction means a chirp sequence direction.

Now, a range resolution ΔR and a relative velocity resolution ΔV of the radar device 43 are expressed by the following expressions.

ΔR=c/(2×B) (1)

ΔV=λ/(2×T_{cs}) (2)

In the expressions, “c” represents the speed of light, B represents a frequency modulation width, and T_{cs} represents a chirp sequence time. The chirp sequence time T_{cs} is a time required for one chirp sequence. In addition, a wavelength λ is expressed by the following expression.

λ=c/f_{c} (3)

In the expression, f_{c} represents a center frequency of the chirp having the frequency modulation width B in FIG. 3. In addition, a distance range is from 0 to ΔR×(N_{RFFT}/2), and a relative velocity range is from 0 to ΔV×N_{VFFT}. For a case in which there is an object that exceeds those ranges, there is a known method of resolving ambiguity through use of time-series information.

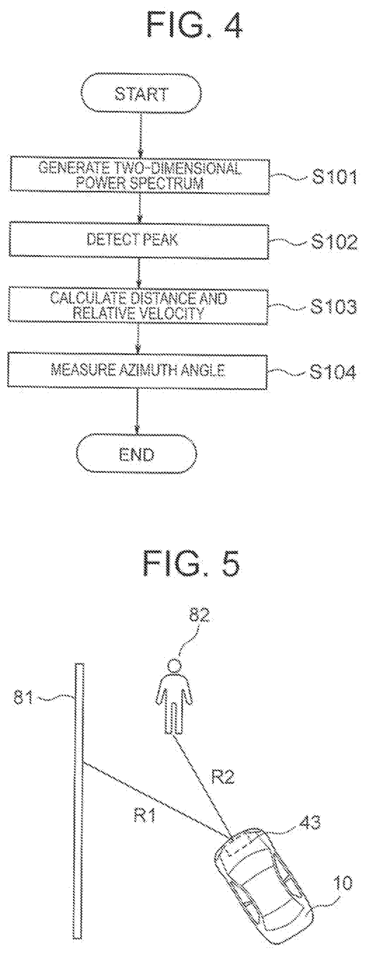

FIG. 4 is a flow chart for illustrating a target object detection routine to be executed by the radar controller 432 of FIG. 2. The routine of FIG. 4 is executed every time a fixed period of time, for example 50 ms, has elapsed.

When the routine of FIG. 4 is started, the radar controller 432 sequentially executes the following processing steps of from Step S101 to Step S104, and after that, temporarily ends this routine.

Step S101: The radar controller 432 executes two-dimensional FFT on the obtained digital voltage data corresponding to four channels to generate a two-dimensional power spectrum.

Step S102: The radar controller 432 executes peak detection on the obtained two-dimensional power spectrum to extract a peak from the two-dimensional power spectrum. Examples of a method of extracting a peak include a publicly known constant false alarm (CFAR) method.

Step S103: The radar controller 432 calculates a distance from the target object and a relative velocity with respect to the target object corresponding to the extracted peak, based on the principle of the publicly known FCM method.

Step S104: The radar controller 432 measures an azimuth angle of the target object corresponding to the extracted peak. As a method of measuring an azimuth angle, for example, a beamformer method is used. This single routine corresponds to the chirp sequence that is repeated at a processing cycle period set in advance.

To describe the processing step of Step S101 more specifically, the radar controller 432 first executes first FFT processing on the digital voltage data in each chirp to generate a power spectrum. For example, as the distance between the radar device 43 and the target object becomes longer, a time delay of the reception signal with respect to the transmitted signal becomes longer. Therefore, the frequency of the beat signal is proportional to the distance between the radar device 43 and the target object.

In the first FFT processing, intensity information on the reception signal and phase information on the reception signal are extracted for each of frequency points set at regular intervals. The frequency point is called “range bin.” As a result of the first FFT processing, a peak appears in a range bin for a frequency corresponding to the distance. That is, the distance from the target object can be obtained by detecting a peak frequency in the first FFT processing. The first FFT processing is executed on the beat signal. Therefore, the first FFT processing is repeated as often as the number of beat signals, namely, the number of chirps.

When second FFT processing is performed with frequency power spectra obtained by the first FFT processing being arranged in time series, a frequency power spectrum in which a peak appears in a frequency bin for the beat frequency is obtained. The frequency bin for the beat frequency is called “relative velocity bin.” In this manner, a two-dimensional power spectrum having the range bin and the relative velocity bin as axes thereof is obtained. For example, when two objects having mutually different distances or two objects having mutually different relative velocities are detected by the radar device 43, two peaks appear on the two-dimensional power spectrum.

FIG. 5 is a schematic view for illustrating a positional relationship among the vehicle 10, the peripheral structure, and the target object. A distance between the radar device 43 and a peripheral structure 81 is represented by R1. In addition, a distance between the radar device 43 and a target object 82 is represented by R2. The target object 82 is present in a vicinity of the peripheral structure 81.

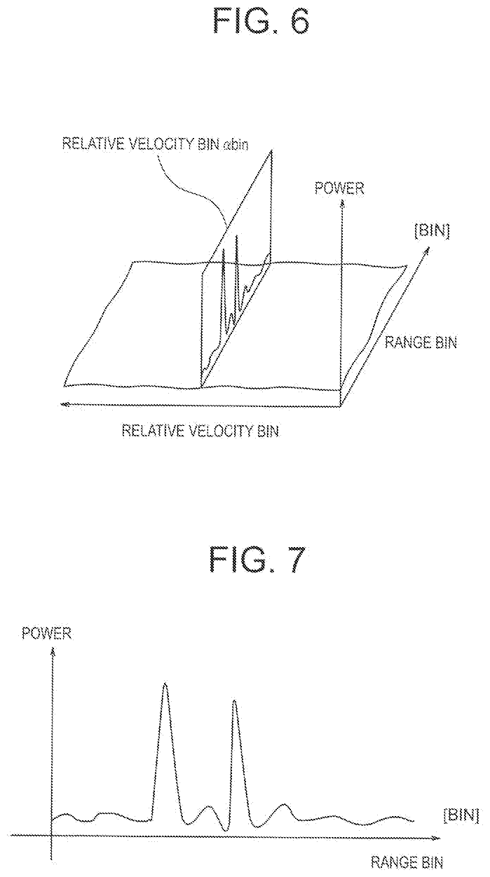

FIG. 6 is a schematic graph for showing an example of a two-dimensional power spectrum obtained when the radar device 43 is used to detect two objects having mutually different distances from the radar device 43. When it is detected that a relative velocity between the vehicle 10 and the peripheral structure 81 and a relative velocity between the vehicle 10 and the target object 82 are equal to each other and the distance R1 and the distance R2 are detected as mutually different distances, two peaks appear in analysis results in a range bin direction that have been calculated by the FFT processing.

FIG. 7 is a graph for showing a power spectrum in a specific relative velocity bin of FIG. 6. On the power spectrum in a specific relative velocity bin αbin of FIG. 6, as the range resolution of the radar device 43 becomes higher, a frequency difference, namely, a range bin difference between the two peaks can be increased.

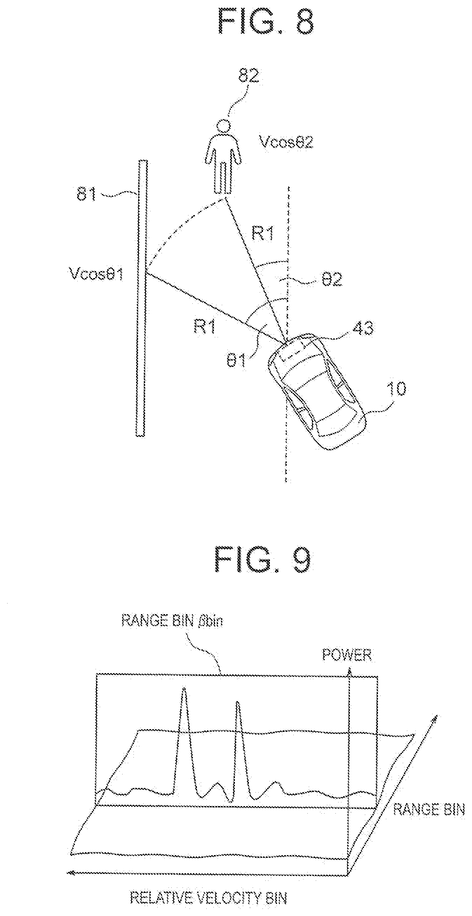

FIG. 8 is a schematic view for illustrating a relationship between the relative velocity between the vehicle 10 and the peripheral structure 81 and the relative velocity between the vehicle 10 and the target object 82. As illustrated in FIG. 8, when a relative velocity difference between the peripheral structure 81 and the target object 82, which are both present at the same distance R1 from the radar device 43, becomes larger than a relative velocity bin difference therebetween, the radar device 43 can separately detect the peripheral structure 81 and the target object 82. For example, when the relative velocity resolution of the radar device 43 is increased, the radar device 43 can separately detect the peripheral structure 81 and the target object 82.

As illustrated in FIG. 8, an azimuth angle of the peripheral structure 81 viewed from the radar device 43 is represented by θ1 and an azimuth angle of the target object 82 viewed from the radar device 43 is represented by θ2. When the peripheral structure 81 and the target object 82 are stationary and the vehicle 10 is traveling at a speed V, the relative velocity between the vehicle 10 and the peripheral structure 81 is obtained as V×cos θ1, and the relative velocity between the vehicle 10 and the target object 82 is obtained as V×cos θ2.

FIG. 9 is a schematic graph for showing an example of a two-dimensional power spectrum obtained when the radar device 43 is used to detect two objects having mutually different relative velocities with respect to the vehicle 10. As shown in FIG. 9, two peaks appear in frequency analysis results in a relative velocity bin direction that have been calculated by the FFT processing.

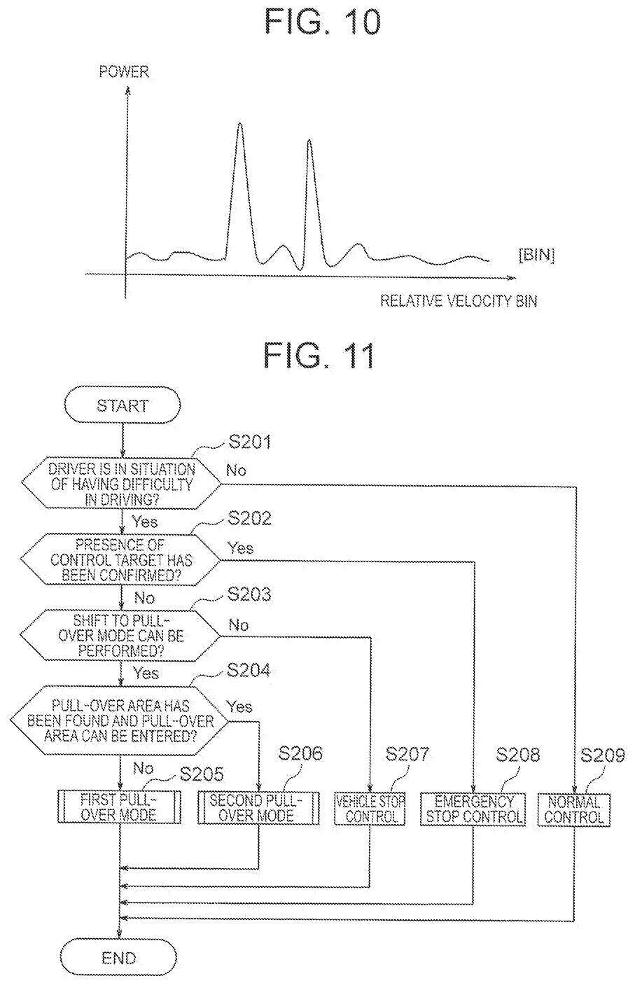

FIG. 10 is a graph for showing a power spectrum in a specific range bin of FIG. 9. On the power spectrum in a specific range bin (bin of FIG. 9, as the relative velocity resolution of the radar device 43 becomes higher, a frequency difference, namely, a relative velocity bin difference between the two peaks can be increased.

The radar device 43 includes a plurality of control modes relating to the range resolution. The plurality of control modes relating to the range resolution include the manual driving compatible mode and the automatic driving compatible mode. The radar controller 432 controls the radar main body 431 in the plurality of control modes relating to the range resolution.

A first range resolution is higher than a second range resolution. The first range resolution is a range resolution to be used in the automatic driving compatible mode. The second range resolution is a range resolution to be used in the manual driving compatible mode. As indicated in Expression (1), a method of increasing the frequency modulation width B is conceivable as means for increasing the range resolution.

The radar device 43 also includes a plurality of control modes relating to the relative velocity resolution. The plurality of control modes relating to the relative velocity resolution include the manual driving compatible mode and the automatic driving compatible mode. The radar controller 432 controls the radar main body 431 in the plurality of control modes relating to the relative velocity resolution.

A first relative velocity resolution is higher than a second relative velocity resolution. The first relative velocity resolution is a relative velocity resolution to be used in the automatic driving compatible mode. The second relative velocity resolution is a relative velocity resolution to be used in the manual driving compatible mode. As indicated in Expression (2), a method of increasing the chirp sequence time T_{cs} is conceivable as means for increasing the relative velocity resolution. In addition, as a result of increasing the chirp sequence time T_{cs}, a time during which radio waves are transmitted becomes longer than in the manual driving compatible mode, and hence this case may be handled by correspondingly increasing the processing cycle period.

The radar device 43 selects, from among the plurality of control modes, a control mode in which at least one of the range resolution or the relative velocity resolution is set higher as the vehicle speed becomes lower.

Further, the radar device 43 selects, from among the plurality of control modes, a control mode in which at least one of the range resolution or the relative velocity resolution is set higher as the distance between the vehicle 10 and the peripheral structure is shorter.

For the sake of simplification, the description has been made on the premise that a height of a reflection point on the peripheral structure 81 and a height of a reflection point on the target object 82 are the same as a height of the radar device 43. However, the same results can be obtained even when the heights of the respective reflection points are different from the height of the radar device 43.

Next, roadside pull-over control to be performed by the driving support controller 61 is described. In the following description, the following control is assumed: while the vehicle 10 is traveling in a leftmost lane, the driver of the vehicle 10 falls into a situation in which the driver has difficulty in driving, and the driving support controller 61 automatically decelerates the vehicle 10 to stop the vehicle 10 at a roadside edge on the left side. However, this roadside pull-over control is applicable to the vehicle 10 irrespective of which lane the vehicle 10 is traveling in or whether the roadside is located on the left side or the right side of the vehicle 10.

FIG. 11 is a flow chart for illustrating a driving mode selection routine to be executed by the driving support controller 61 of FIG. 1. The routine of FIG. 11 is a routine indicating which driving mode is to be selected by the driving support controller 61 based on the state of the driver and circumstances in the periphery of the vehicle 10. The routine of FIG. 11 is executed every time a fixed period of time, for example 50 ms, has elapsed.

When the routine of FIG. 11 is started, the driving support controller 61 determines in Step S201 whether or not the driver of the vehicle 10 is in a situation in which the driver has difficulty in driving based on the information received from the driver monitor 30. When the driver of the vehicle 10 is not in a situation in which the driver has difficulty in driving, the driving support controller 61 selects a “normal control mode” as the driving mode in Step S209, and temporarily ends this routine. The “normal control mode” is a mode in which normal vehicle control is executed. In this case, the driving support controller 61 continues the normal vehicle control without executing the roadside pull-over control. The normal vehicle control refers to control to be performed when the driving entity of the vehicle 10 is the driver, and can also be rephased as “manual driving control.”

Meanwhile, when the driver of the vehicle 10 is in a situation in which the driver has difficulty in driving, the driving support controller 61 determines in Step S202 whether or not presence of a control target has been confirmed based on the information received from the object detection device 40. When the presence of a control target has been confirmed, the driving support controller 61 selects an “emergency stop control mode” as the driving mode in Step S208, and temporarily ends this routine.

The “emergency stop control mode” is a mode in which the vehicle 10 is automatically brought to an emergency stop in order to avoid collision between the vehicle 10 and the control target. The emergency stop refers to braking of the vehicle 10 by, for example, emergency stop braking. In this case, in Step S208, the driving support controller 61 sets a deceleration of the vehicle 10 based on the distance between the vehicle 10 and the control target and the state of the driver. For example, when a control target has been detected to be in extremely close proximity to the vehicle 10, the deceleration may be set as high as possible, and when the distance between the vehicle 10 and the control target is relatively long, the deceleration may be set relatively gentle.

Meanwhile, when the presence of a control target has not been confirmed, the driving support controller 61 determines in Step S203 whether or not the driving mode can be shifted to the pull-over mode. The pull-over mode is a mode in which the vehicle 10 is pulled over to the roadside. In addition, a case in which the shift to the pull-over mode cannot be performed is, for example, a case in which the radar device 43 fails, a case in which an elapsed time after the driver falls into a situation in which the driver has difficulty in driving exceeds a specified time, and a case in which a distance traveled after the driver falls into a situation in which the driver has difficulty in driving exceeds a specified distance.

When the driving mode cannot be shifted to the pull-over mode, the driving support controller 61 selects a “vehicle stop control mode” as the driving mode in Step S207, and temporarily ends this routine. The “vehicle stop control mode” refers to a mode in which the vehicle 10 is quickly decelerated and stopped.

Meanwhile, when the driving mode can be shifted to the pull-over mode, the driving support controller 61 determines in Step S204 whether or not a pull-over area has been found and the vehicle 10 can enter the pull-over area. The pull-over area is an area having a size enough to stop the vehicle 10 therein. The pull-over area is searched for based on the information received from the object detection device 40 at a time point before the driver falls into a situation in which the driver has difficulty in driving. For example, the driving support controller 61 estimates a coordinate position of the vehicle 10 based on information received from the locator 45, and compares the estimated coordinate position and the map information to each other, to thereby search for the position of the pull-over area in the periphery of the vehicle 10.

Whether or not the vehicle 10 can enter the pull-over area is determined by determining based on the information received from the object detection device 40 whether or not an obstacle is present in the pull-over area. The driving support controller 61 determines that the vehicle 10 can enter the pull-over area when an obstacle is not present in the pull-over area, and determines that the vehicle 10 cannot enter the pull-over area when an obstacle is present in the pull-over area.

When a pull-over area is found and the vehicle 10 can enter the pull-over area, the driving support controller 61 selects a “second pull-over mode” as the driving mode in Step S206, and temporarily ends this routine. Meanwhile, when a pull-over area is not found or when the vehicle 10 cannot enter the pull-over area, the driving support controller 61 selects a “first pull-over mode” as the driving mode in Step S205, and temporarily ends this routine.

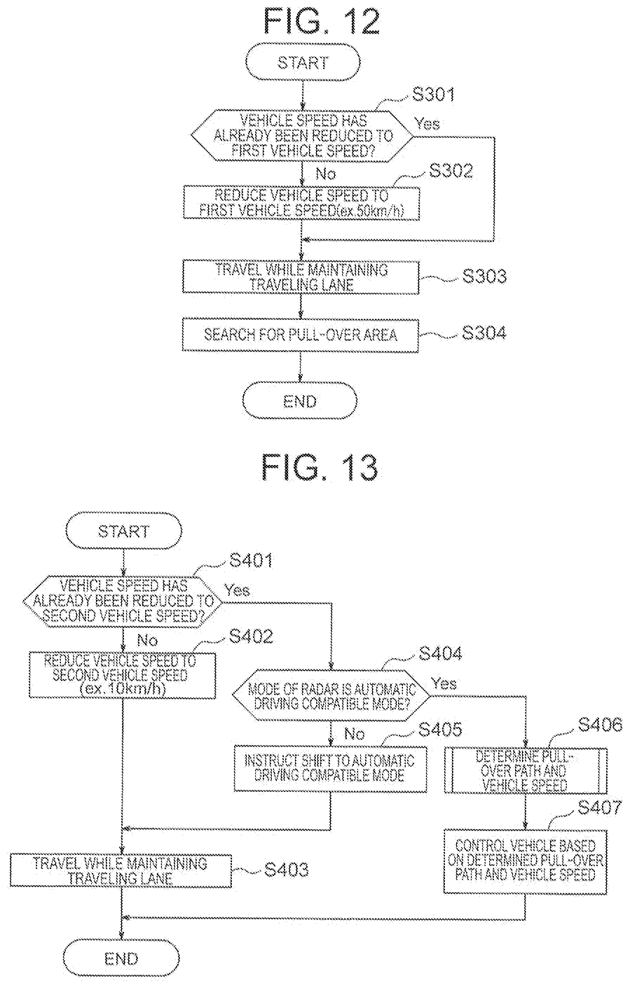

FIG. 12 is a flow chart for illustrating a first pull-over mode routine of Step S205 of FIG. 11. The first pull-over mode routine is a routine to be executed by the roadside pull-over controller 70. When the routine of FIG. 12 is started, the roadside pull-over controller 70 determines in Step S301 whether or not the vehicle speed has already been reduced to a first vehicle speed.

When the vehicle speed has already reduced to the first vehicle speed, in Step S303, the roadside pull-over controller 70 causes the vehicle 10 to maintain a lane in which the vehicle 10 is currently traveling. Meanwhile, when the vehicle speed has not been reduced to the first vehicle speed, in Step S302, the roadside pull-over controller 70 reduces the vehicle speed to the first vehicle speed. For example, the first vehicle speed is set to 50 km/h. A reason for reducing the vehicle speed to the first vehicle speed is to reduce collision damage caused to the periphery by the vehicle 10.

Subsequently, in Step S303, the roadside pull-over controller 70 causes the vehicle 10 to maintain the lane in which the vehicle 10 is currently traveling. As methods of causing the vehicle 10 to maintain a lane, there are a method of correcting a traveling position of the vehicle 10 based on the information received from the locator 45 and the map information and controlling the vehicle 10 in accordance with the correction and a method of controlling the vehicle 10 based on information regarding the white lines photographed by the camera 42.

Subsequently, in Step S304, the roadside pull-over controller 70 searches for a pull-over area, and temporarily ends this routine.

FIG. 13 is a flow chart for illustrating a second pull-over mode routine of Step S206 of FIG. 11. The routine of FIG. 13 is a routine to be executed by the roadside pull-over controller 70. When the routine of FIG. 13 is started, the roadside pull-over controller 70 determines in Step S401 whether or not the vehicle speed has already been reduced to a second vehicle speed. For example, the second vehicle speed is set to 10 km/h. A reason for reducing the vehicle speed to the second vehicle speed is to decelerate the vehicle 10 to a speed that allows the vehicle 10 to immediately stop.

When the vehicle speed has not been reduced to the second vehicle speed, in Step S402, the roadside pull-over controller 70 reduces the vehicle speed to the second vehicle speed. Subsequently, in Step S403, the roadside pull-over controller 70 causes the vehicle 10 to maintain the lane in which the vehicle 10 is traveling.

Meanwhile, when the vehicle speed has been reduced to the second vehicle speed, the roadside pull-over controller 70 determines in Step S404 whether or not an operating mode of the radar device 43 is set to the automatic driving compatible mode.

When the operating mode of the radar device 43 is not the automatic driving compatible mode, in Step S405, the roadside pull-over controller 70 shifts the operating mode of the radar device 43 to the automatic driving compatible mode. Subsequently, in Step S403, the roadside pull-over controller 70 causes the vehicle 10 to maintain the lane in which the vehicle 10 is currently traveling.

Meanwhile, when the operating mode of the radar device 43 is the automatic driving compatible mode, in Step S406, the roadside pull-over controller 70 determines a pull-over path and a vehicle speed. Subsequently, in Step S407, the roadside pull-over controller 70 transmits, to the actuator controller 62, an instruction for controlling the vehicle 10 based on the determined pull-over path and the determined vehicle speed, and temporarily ends this routine.

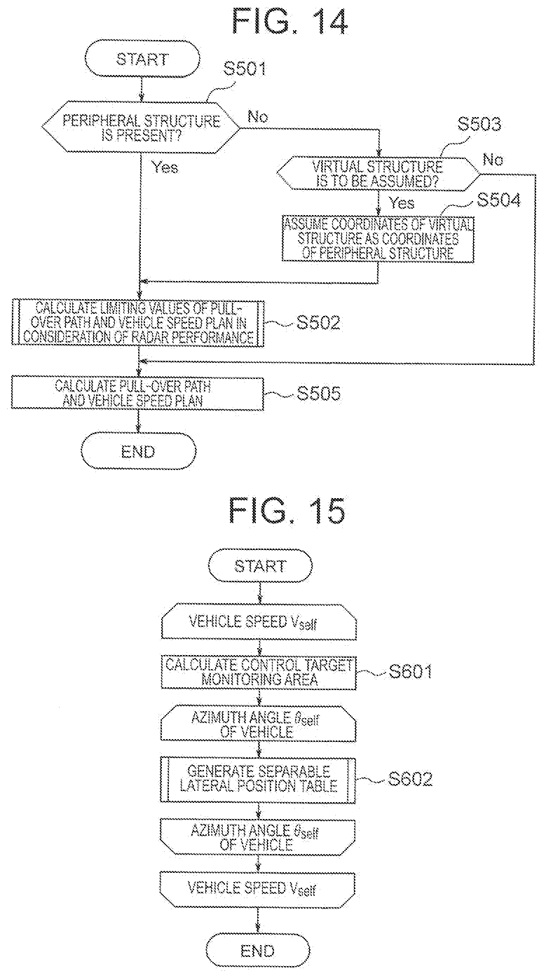

FIG. 14 is a flow chart for illustrating a pull-over-path-and-vehicle-speed-plan calculation routine of Step S406 of FIG. 13. The pull-over-path-and-vehicle-speed-plan calculation routine is a routine to be executed by the pull-over path determiner 71 or the vehicle motion limiter 72. When the routine of FIG. 14 is started, the pull-over path determiner 71 determines in Step S501 whether or not the peripheral structure 81 is present.

When it is determined that the peripheral structure 81 is present, in Step S502, the vehicle motion limiter 72 calculates a limiting value of the pull-over path and a limiting value of a vehicle speed plan in consideration of performance of the radar device 43. Whether or not the peripheral structure 81 is present is determined based on, for example, the information received from the object detection device 40. In Step S501, for example, when the peripheral structure 81 has been detected to be present at a lateral position of 5 m from the vehicle 10 based on the information received from the object detection device 40, a distance from the peripheral structure 81 is assumed to be 5 m.

As a method of detecting the peripheral structure 81, there is, for example, a method of estimating a position of the peripheral structure 81 based on positional information on a stationary object detected by the radar device 43. There is also a method of estimating the traveling position of the vehicle 10 based on the information received from the locator 45 and estimating the position of the peripheral structure 81 with respect to the traveling position of the vehicle 10 by comparing the traveling position and the map information to each other. Subsequently, in Step S505, the pull-over path determiner 71 calculates the pull-over path and the vehicle speed plan within a range of the calculated limiting values, and temporarily ends this routine.

Meanwhile, when it is determined that the peripheral structure 81 is not present, the pull-over path determiner 71 determines in Step S503 whether or not to assume a virtual structure. For example, when a function of the radar device 43 is restricted so as not to detect a stationary object, the radar device 43 may not be able to detect the peripheral structure 81. In such a case, in Step S503, it is assumed that the peripheral structure 81 is present in a periphery of a planned travel path of the vehicle 10. The peripheral structure 81 assumed in this manner is referred to as “virtual structure.”

When a virtual structure is assumed, in Step S504, the pull-over path determiner 71 assumes coordinates of the virtual structure as coordinates of the peripheral structure 81.

For example, even when the peripheral structure 81 is not detected based on the information received from the object detection device 40, in a case in which detection accuracy of the peripheral structure 81 exhibited by the object detection device 40 is expected to be low, the vehicle 10 may be constantly controlled on the assumption that a virtual structure is present. In such a case, the determination of Step S503 always results in “Yes.”

In another example, when a determination result of presence/absence of the peripheral structure 81 based on information received from the camera 42 and a determination result of presence/absence of the peripheral structure 81 based on the information received from the radar device 43 are different from each other, the determination of the presence or absence of the peripheral structure 81 cannot be verified. In such a case, “Yes” may be determined as a result of Step S503.

Subsequently, in Step S502, the vehicle motion limiter 72 calculates the limiting value of the pull-over path and the limiting value of the vehicle speed plan in consideration of the performance of the radar device 43.

Subsequently, in Step S505, the pull-over path determiner 71 calculates the pull-over path and the vehicle speed plan within the range of the calculated limiting values, and temporarily ends this routine.

Meanwhile, when the virtual structure is not assumed, in Step S505, the pull-over path determiner 71 calculates the pull-over path and the vehicle speed plan, and temporarily ends this routine.

Now, the calculation of the limiting value of the pull-over path and the calculation of the limiting value of the vehicle speed plan, which are performed in Step S502, are described in more detail. The calculation of the limiting value of the pull-over path and the calculation of the limiting value of the vehicle speed plan are performed so as to allow the radar device 43 to separately detect an object assumed to be present within the control target monitoring area and the peripheral structure 81. Therefore, the calculation of the limiting value of the pull-over path and the calculation of the limiting value of the vehicle speed plan are performed based on the position of the vehicle 10 and the position of the peripheral structure 81.

The positional relationship between the vehicle 10 and the peripheral structure 81 changes depending on the position of the vehicle 10, the vehicle speed, and the azimuth angle of the vehicle 10. Therefore, a vehicle speed V_{self}, an azimuth angle θ_{self} of the vehicle 10, a lateral position Y_{self} of the vehicle 10, and a longitudinal position X_{self} of the vehicle 10 are set as parameters for the limiting value of the pull-over path and the limiting value of the vehicle speed plan.

First, a case in which the peripheral structure 81 is arranged linearly along a road is described. The azimuth angle θ_{self} of the vehicle 10 is an angle formed between a direction conforming to the road and the traveling direction of the vehicle 10. Even when the peripheral structure 81 is not completely arranged linearly, the calculation may be performed by regarding the peripheral structure 81 as a straight line, or the calculation may be performed by approximating the peripheral structure 81 to a straight line.

FIG. 15 is a flow chart for illustrating a pull-over-path-and-vehicle-speed-plan limiting value calculation routine of Step S502 of FIG. 14. The routine of FIG. 15 is a routine to be executed by the vehicle motion limiter 72. When the routine of FIG. 15 is started, in Step S601, the vehicle motion limiter 72 calculates the control target monitoring area for each vehicle speed V_{self}.

Subsequently, in Step S602, the vehicle motion limiter 72 generates a separable lateral position table for the vehicle speed V_{self} and the azimuth angle θ_{self} of the vehicle 10, and temporarily ends this routine.

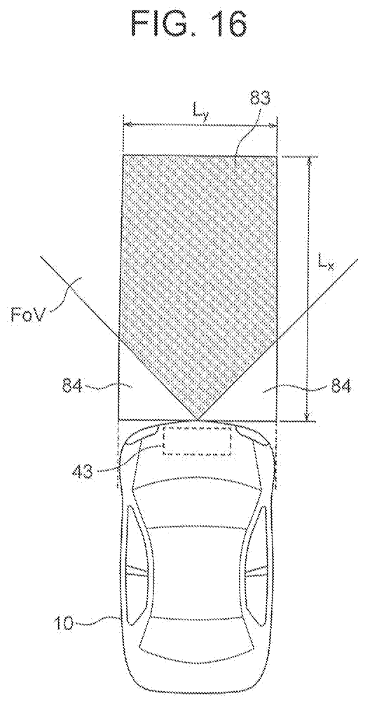

FIG. 16 is a schematic view for illustrating the control target monitoring area. A length Lₓ of a control target monitoring area 83 in the traveling direction of the vehicle 10 is defined as a sum of a free running distance of the vehicle 10, a braking distance due to emergency braking, and a margin up to the control target. A length Ly of the control target monitoring area 83 in the width direction of the vehicle 10 is defined as a width of the vehicle 10 plus margins. Non-target areas 84 are areas beyond a field of view (FoV; detection target range) of the radar device 43. In the first embodiment, the non-target areas 84 are not included in the control target monitoring area 83. In order to control the vehicle 10, there is a case in which information on an area outside the FoV of the radar device 43 is required. In such a case, for example, the information received from the camera 42, information received from the ultrasonic sensor 44, and information detected by the radar device 43 in the past are used.

The free running distance is represented by a product of the vehicle speed immediately before start of braking due to emergency braking and a free running time. The free running time includes a processing time of the radar device 43 and a delay time after the driving support controller 61 outputs an emergency brake control command to the actuator controller 62 until a braking force is actually generated.

The braking distance due to emergency braking is a distance by which the vehicle 10 is moved after the braking force is actually generated until the vehicle 10 is stopped. The margin up to the control target is a distance margin between a position at which the vehicle 10 is stopped by emergency braking and a position of the control target.

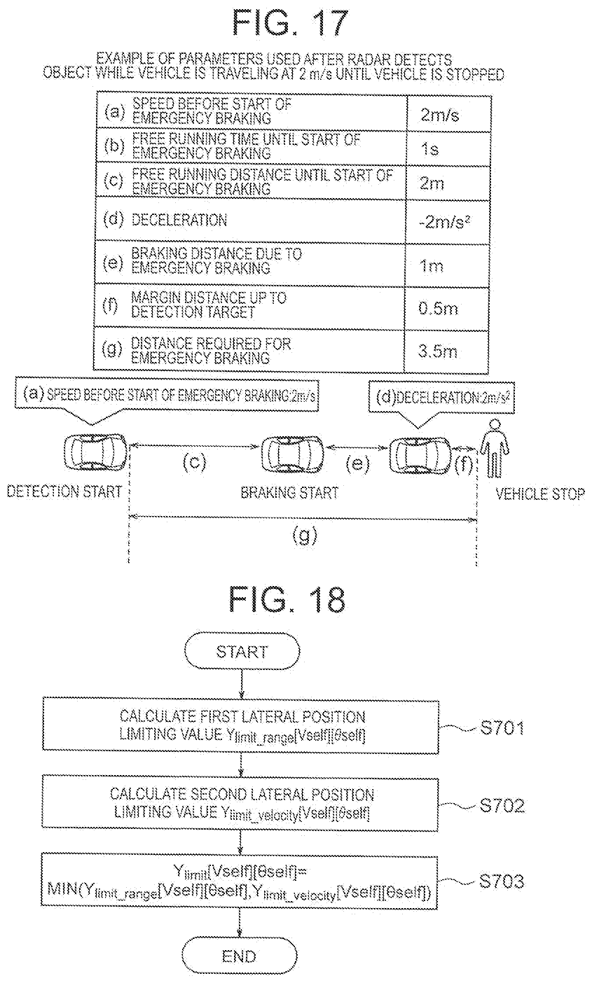

FIG. 17 is a schematic diagram for illustrating an example of a flow after the object is detected by the radar device 43 until the vehicle 10 is stopped. Assuming that the vehicle speed immediately before the start of braking due to emergency braking is 2 m/s and the free running time is 1 s, the free running distance is 2 m. In addition, assuming that the deceleration is set to −2 m/s², the braking distance due to emergency braking is 1 m. Assuming that the margin up to a detection target is 0.5 m, a sum of the free running distance, the braking distance due to emergency braking, and the margin up to the detection target is 3.5 m. That is, the length Lₓ of the control target monitoring area 83 in the traveling direction of the vehicle 10 is 3.5 m.

Further, assuming that, for example, the width of the vehicle 10 is 1.8 m and the margins in the width direction are 0.1 m on both left and right sides, the length Ly of the control target monitoring area 83 in the width direction of the vehicle 10 is calculated as 2.0 m.

FIG. 18 is a flow chart for illustrating a separable lateral position table creation routine of Step S602 of FIG. 15. The routine of FIG. 18 is a routine to be executed by the vehicle motion limiter 72. When the routine of FIG. 18 is started, in Step S701, the vehicle motion limiter 72 calculates a first lateral position limiting value Y_{limit_range}[V_{self}] [θ_{self}]. The first lateral position limiting value Y_{limit_range}[V_{self}] [θ_{self}] is a lateral position limiting value that allows the peripheral structure 81 and the target object 82 to be separately detected in the range direction.

Subsequently, in Step S702, the vehicle motion limiter 72 calculates a second lateral position limiting value Y_{limit_velocity}[V_{self}] [θ_{self}]. The second lateral position limiting value Y_{limit_velocity}[V_{self}] [θ_{self}] is a lateral position limiting value that allows the peripheral structure 81 and the target object 82 to be separately detected in the relative velocity direction.

Subsequently, in Step S703, the vehicle motion limiter 72 selects, as the lateral position limiting value, the smaller one of the first lateral position limiting value Y_{limit_range}[V_{self}] [θ_{self}] or the second lateral position limiting value Y_{limit_velocity}[V_{self}] [θ_{self}]. The vehicle motion limiter 72 creates a separable lateral position table Yₗᵢₘᵢₜ[V_{self}] [θ_{self}] based on the selected lateral position limiting value. This means that the limiting value of the lateral position that allows the peripheral structure 81 and the target object 82 to be separately detected in one of the range direction or the relative velocity direction is selected.

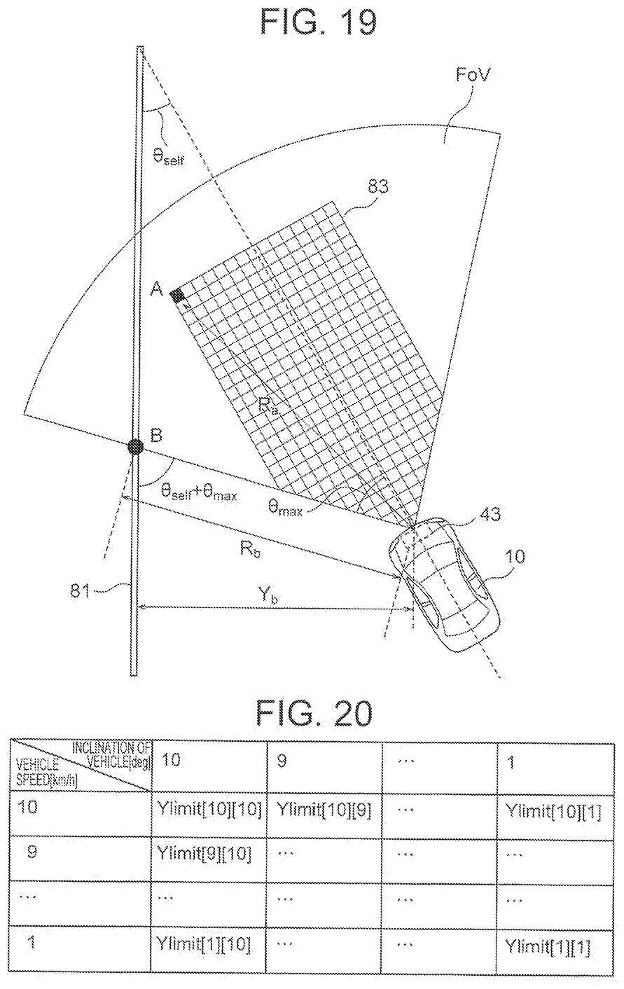

FIG. 19 is a view for illustrating a method of calculating the first lateral position limiting value Y_{limit_range} [V_{self}] [θ_{self}] when the peripheral structure 81 is linearly arranged. The lateral position of the vehicle 10 that allows an object within the control target monitoring area 83 serving as the target object and the peripheral structure 81 to be separately detected in the range direction is calculated from the vehicle speed V_{self} and the azimuth angle θ_{self} of the vehicle 10.

Whether or not the peripheral structure 81 and the target object can be separately detected in the range direction can be determined by determining whether or not the object assumed to be present at a point A of FIG. 19 is detected separately from the peripheral structure 81. The point A is a point farthest from the vehicle 10 and closest to the peripheral structure 81 in the control target monitoring area 83. In the first embodiment, it is assumed that the peripheral structure 81 is continuously present linearly, and hence an area at a certain distance or more from the radar device 43 is assumed to be an area that cannot be separately detected in the range direction.

A condition for separately detecting the object assumed to be present at the point A and the peripheral structure 81 is that a difference between a distance R_{b} between a point B and the radar device 43 and a distance Rₐ between the point A and the radar device 43 is larger than a range difference Rₛₑₚₐᵣₐₜₑ for enabling separate detection by the radar device 43. The point B is a point on the peripheral structure 81 which is closest to the radar device 43 within the FoV. That is, Expression (4) is satisfied.

Rₐ+Rₛₑₚₐᵣₐₜₑ<R_{b} (4)

The distance R_{b} between the point B and the radar device 43 is expressed by Expression (5). In Expression (5), θₘₐₓ represents a maximum value of an angular direction of the FoV, Y_{b} represents a relative lateral position of the radar device 43 with respect to the peripheral structure 81, and θ_{self} represents the azimuth angle of the vehicle 10.

R_{b}=Y_{b}/sin(θₘₐₓ+θ_{self}) (5)

That is, when Expression (6) or Expression (7) is satisfied, the object assumed to be present at the point A and the peripheral structure 81 are separately detected in the range direction by the radar device 43.

Rₐ+Rₛₑₚₐᵣₐₜₑ<Y_{b}/sin(θₘₐₓ+θ_{self}) (6)

sin(θₘₐₓ+θ_{self})×(Rₐ+Rₛₑₚₐᵣₐₜₑ)<Y_{b} (7)

When the distance Rₐ between the point A and the radar device 43, the maximum value θₘₐₓ of the FoV of the radar device 43 in the angular direction, the distance R_{b} between the point B and the radar device 43, and the azimuth angle θ_{self} of the vehicle 10 are fixed to some values, the lateral position Y_{b} required for separately detecting two objects in the range direction is determined.

As a first example, assuming that Rₐ is 5 m, Rₛₑₚₐᵣₐₜₑ is 0.2 m, θₘₐₓ is 45 degrees, and θ_{self} is 0 degrees, Expression (8) is established.

Y_{b}>3.7m (8)

That is, when the radar device 43 is linearly moved along a position farther than 3.7 m from the linear peripheral structure 81 in parallel thereto, the radar device 43 can separately detect the object at the point A and the peripheral structure 81 in the range direction.

Further, when θ_{self} is set to 10 degrees in the first example, Expression (9) is established.

Y_{b}>4.3m (9)

This means that the radar device 43 cannot separately detect two objects in the range direction unless the vehicle 10 is moved farther away from the peripheral structure 81 as the azimuth angle θ_{self} of the vehicle 10 becomes larger, that is, as the traveling direction of the vehicle 10 becomes closer to a direction perpendicular to the peripheral structure 81.

Further, when Rₐ is set to 3 m in the first example, Expression (10) is established.

Y_{b}>2.3m (10)

As the vehicle speed V_{self} becomes lower, Rₐ becomes smaller, and the control target monitoring area 83 becomes smaller. Therefore, this means that the radar device 43 can further separately detect two objects in the range direction even when the vehicle 10 becomes closer to the peripheral structure 81 as the vehicle speed V_{self} becomes lower.

As described above, the first lateral position limiting value Y_{limit_range}[V_{self}] [θ_{self}] is defined as follows. The first lateral position limiting value Y_{limit_range} [V_{self}] [θ_{self}] is calculated for each vehicle speed V_{self} and each azimuth angle θ_{self} of the vehicle 10.

Y_{limit_range}[V_{self}][θ_{self}]=sin(θₘₐₓ+θ_{self})×(Rₐ+Rₛₑₚₐᵣₐₜₑ) (11)

FIG. 20 is a table for showing an example of the separable lateral position table obtained when the peripheral structure 81 is linearly arranged. The first lateral position limiting value Y_{limit_range}[V_{self}] [θ_{self}] represents relative coordinates with respect to the peripheral structure 81, and hence a relationship with the lateral position Y_{self} of the vehicle 10 is expressed by Expression (12). In Expression (12), a lateral position Yₛₜₐₜ represents a lateral position of the peripheral structure 81 with a freely-set coordinate position being used as the origin, and the lateral position Y_{self} represents a lateral position of the vehicle 10 with a freely-set coordinate position being used as the origin.

Y_{limit_range}[V_{self}][θ_{self}]=Y_{self}−Yₛₜₐₜ (12)

An antenna gain of the radar device 43 often tends to decrease as the FoV of the radar device 43 increases. Thus, it is more difficult for a wider-angle antenna to detect the target object. Therefore, the maximum value θₘₐₓ of the FoV of the radar device 43 may be determined in consideration of the antenna gain. Further, in consideration that an intensity of the reflected waves decreases due to attenuation as the distance from the target object increases, the maximum value θₘₐₓ of the FoV of the radar device 43 may be set to a value that differs for each distance.

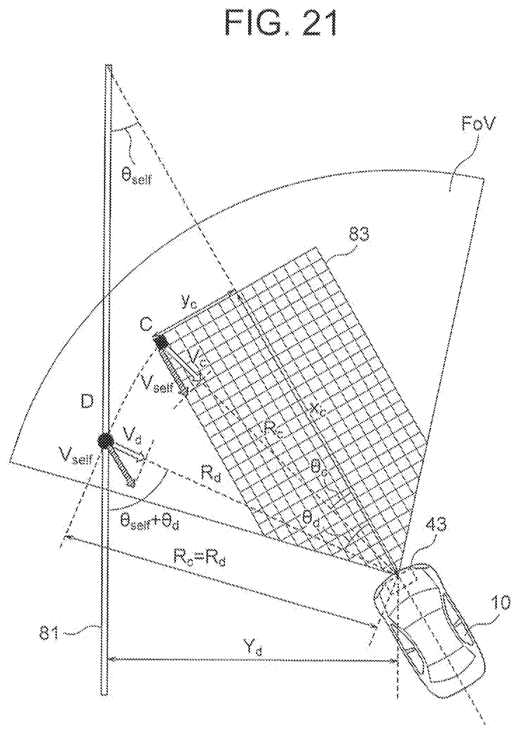

FIG. 21 is a view for illustrating a method of calculating the second lateral position limiting value Y_{limit_velocity}[V_{self}] [θ_{self}] when the peripheral structure 81 is linearly arranged. The lateral position of the vehicle 10 that allows an object within the control target monitoring area 83 and the peripheral structure 81 to be separately detected in the relative velocity direction is calculated from the vehicle speed and the azimuth angle of the vehicle 10, in the same manner as in the lateral position of the vehicle 10 that allows the object and the peripheral structure 81 to be separately detected in the range direction.

Whether or not the peripheral structure 81 and the target object can be separately detected in the relative velocity direction can be determined by determining whether or not the object assumed to be present at a point C of FIG. 21 is detected separately from the peripheral structure 81. The point C is a point farthest from the vehicle 10 and closest to the peripheral structure 81 in the control target monitoring area 83.

When a longitudinal position of the point C viewed from the radar device 43 is represented by x_{c} and the lateral position of the point C viewed from the radar device 43 is represented by y_{c}, the azimuth angle θ_{c} of the point C viewed from the radar device 43 is expressed by the following Expression (13).

θ_{c}=a tan(y_{c}/x_{c}) (13)

A magnitude of a relative velocity V_{c} of the object assumed to be present at the point C is detected by the radar device 43 and expressed by Expression (14).

V_{c}=V_{self}×cos θ_{c} (14)

A condition for separately detecting the object assumed to be present at the point C and the peripheral structure 81 is that a difference between a relative velocity V_{d} of the peripheral structure 81 and the relative velocity V_{c} of the object assumed to be present at the point C is larger than a relative velocity difference Vₛₑₚₐᵣₐₜₑ for enabling separate detection by the radar device 43. In the first embodiment, the peripheral structure 81 being a stationary object is present on a wide-angle side of the control target monitoring area 83, and hence the relative velocity V_{c} of the object assumed to be present at the point C is higher than the relative velocity V_{d} Of the peripheral structure 81. Therefore, the condition for separately detecting the object assumed to be present at the point C and the peripheral structure 81 is expressed by Expression (15).

V_{c}−Vₛₑₚₐᵣₐₜₑ>V_{d} (15)

The object assumed to be present at the point C and the peripheral structure 81 are positioned equidistant from the radar device 43. In FIG. 21, a distance R_{c} between the point C and the radar device 43 and a distance R_{d} between the peripheral structure 81 and the radar device 43 are equal to each other. Therefore, the relative velocity V_{d} Of the peripheral structure 81 is expressed by Expression (16).

V_{d}=V_{self}×cos θ_{d} (16)

Further, when a relative lateral position of the radar device 43 with respect to the peripheral structure 81 is represented by Y_{d}, θ_{d} is expressed by Expression (17).

θ_{d}+θ_{self}=a sin(Y_{d}/R_{c}) (17)

R_{c}=(x_{c}²+y_{c}²)^{1/2} (18)

That is, when Expression (19) or Expression (20) is satisfied, the object assumed to be present at the point C and the peripheral structure 81 are separately detected in the relative velocity direction by the radar device 43.

V_{self}×cos θ_{c}−Vₛₑₚₐᵣₐₜₑ>V_{self}×cos θ_{d} (19)

cos θ_{c}−Vₛₑₚₐᵣₐₜₑ/V_{self}>cos θ_{d} (20)

In this case, when 0<θ_{d}<90 degrees and 0<θ_{c}<90 degrees, cos θ decreases as θ increases, and hence Expression (20) can be replaced by Expression (21).

a cos(cos θ_{c}−(Vₛₑₚₐᵣₐₜₑ/V_{self}))<θ_{d} (21)

When θ_{d} of Expression (17) is replaced by the inequality of Expression (21), Expression (22) or Expression (23) is obtained.

a cos(cos θ_{c}−(Vₛₑₚₐᵣₐₜₑ/V_{self}))+θ_{self}<a sin(Y_{d}/R_{c}) (22)

a cos(cos θ_{c}−(Vₛₑₚₐᵣₐₜₑ/V_{self}))<a sin(Y_{d}/R_{c})−θ_{self} (23)

When 0<a sin(Y_{d}/R_{c})<90 degrees, sin θ increases as θ increases, and hence Expression (22) is expressed by Expression (24) or Expression (25).

sin{a cos(cos θ_{c}−(Vₛₑₚₐᵣₐₜₑ/V_{self}))+θ_{self}}<Y_{d}/R_{c} (24)

R_{c}×sin{a cos(cos θ_{c}−(Vₛₑₚₐᵣₐₜₑ/V_{self}))+θ_{self}}<Y_{d} (25)

When R_{c}, θ_{c}, Vₛₑₚₐᵣₐₜₑ, V_{self}, and θ_{self} are fixed to some values, Y_{d} required for separately detecting two objects in the relative velocity direction is determined.

As a first example, assuming that V_{self} is 10 km/h, x_{c} is 5 m, y_{c} is 0.9 m, Vₛₑₚₐᵣₐₜₑ is 0.1 m/s, R_{c} is 5.08 m, θ_{c} is 10.2 degrees, and θ_{self} is 0 degrees, Expression (26) is established.

Y_{d}>1.61m (26)

That is, when the radar device 43 is linearly moved along a position farther than 1.61 m from the linear peripheral structure 81 in parallel thereto, the radar device 43 can separately detect the object at the point C and the peripheral structure 81 in the relative velocity direction.

Further, when θ_{self} is set to 10 degrees in the first example, Expression (27) is established.

Y_{d}>2.43m (27)

This means that the radar device 43 cannot separately detect two objects in the relative velocity direction unless the vehicle 10 is moved farther away from the peripheral structure 81 as the azimuth angle θ_{self} of the vehicle 10 becomes larger, that is, as the traveling direction of the vehicle 10 becomes closer to a direction perpendicular to the peripheral structure 81.

Further, when V_{self} is set to 5 km/h, x_{c} is set to 3 m, y_{c} is set to 0.9 m, R_{c} is set to 3.13 m, and θ_{c} is set to 16.7 degrees in the first example, Expression (28) is established.

Y_{d}>1.45m (28)

As the vehicle speed V_{self} becomes lower, x_{c} becomes smaller, and the control target monitoring area 83 becomes smaller. Therefore, this means that the radar device 43 can further separately detect the peripheral structure 81 and the object at the point C in the relative velocity direction even when the vehicle 10 becomes closer to the peripheral structure 81 as the vehicle speed V_{self} becomes lower.

As described above, the second lateral position limiting value Y_{limit_velocity}[V_{self}] [θ_{self}] is defined as follows.

Y_{limit_velocity}[V_{self}][θ_{self}]=R_{c}×sin{a cos(cos θ_{c}−(Vₛₑₚₐᵣₐₜₑ/V_{self}))+θ_{self}} (29)

The second lateral position limiting value Y_{limit_velocity}[V_{self}] [θ_{self}] is calculated for each vehicle speed V_{self} and each azimuth angle θ_{self} of the vehicle 10. Then, in the same manner as in the case of the first lateral position limiting value Y_{limit_range}[V_{self}] [θ_{self}], such a table as shown in FIG. 20 is created.

The second lateral position limiting value Y_{limit_velocity}[V_{self}] [θ_{self}] represents relative coordinates with respect to the peripheral structure 81, and hence a relationship with the lateral position Y_{self} of the vehicle 10 is expressed by the following expression. In this case, the lateral position Yₛₜₐₜ represents a lateral position of the peripheral structure 81 with a freely-set coordinate position being used as the origin, and the lateral position Y_{self} represents a lateral position of the vehicle 10 with a freely-set coordinate position being used as the origin.

Y_{limit_velocity}[V_{self}][θ_{self}]=Y_{self}−Yₛₜₐₜ (30)

It has been assumed that R_{c} and R_{d} are equal to each other, but R_{c} and R_{d} may differ from each other. In addition, a range difference for enabling separate detection by the radar device 43 may be taken into consideration.

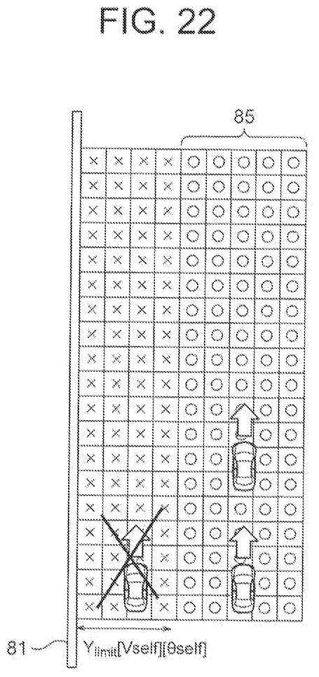

FIG. 22 is a schematic view for illustrating a travelable area 85 of the vehicle 10 to be used when the vehicle 10 travels straight in a case in which the peripheral structure 81 is linearly arranged. In FIG. 22, in a coordinate map provided for each vehicle speed V_{self} and each azimuth angle θ_{self} of the vehicle 10, an area in which the vehicle 10 can travel is marked with “o” and an area in which the vehicle 10 cannot travel is marked with “x” based on the calculated separable lateral position table Yₗᵢₘᵢₜ [V_{self}] [θ_{self}]. That is, the travelable area 85 is the area marked with “o”.

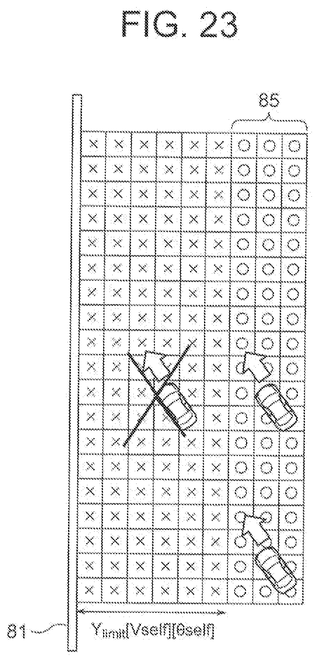

FIG. 23 is a schematic view for illustrating the travelable area 85 of the vehicle 10 to be used when the vehicle 10 travels while approaching the peripheral structure 81 in the case in which the peripheral structure 81 is linearly arranged. As the traveling direction of the vehicle 10 becomes closer to the direction perpendicular to the peripheral structure 81, the lateral position limiting value increases, and hence the travelable area 85 becomes narrower in a lateral direction thereof in FIG. 23 than in FIG. 22.

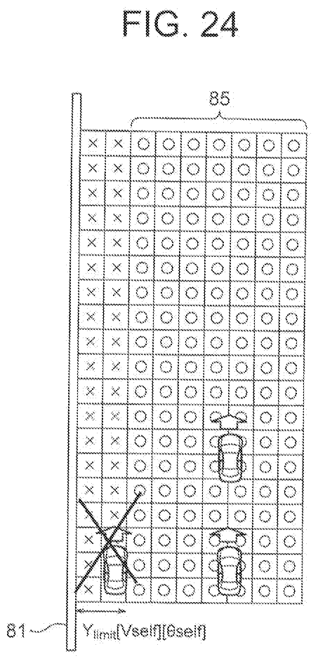

FIG. 24 is a schematic view for illustrating the travelable area 85 of the vehicle 10 to be used when the vehicle 10 travels straight at a low speed in the case in which the peripheral structure 81 is linearly arranged. Traveling straight at a low speed refers to a state in which the vehicle 10 is traveling straight at a vehicle speed lower than the vehicle speed in the example illustrated in FIG. 22. The lateral position limiting value decreases as the vehicle speed decreases, and hence the travelable area 85 is wider in the lateral direction in FIG. 24 than in FIG. 22.

Next, a method of calculating the pull-over path and the vehicle speed plan to be performed by the pull-over path determiner 71 is described in more detail. After the separable lateral position table is created for each vehicle speed V_{self} and each azimuth angle θ_{self} of the vehicle 10 by the vehicle motion limiter 72, the pull-over path determiner 71 performs calculation of the pull-over path and calculation of the vehicle speed plan for causing the vehicle 10 to travel in such a travelable area as illustrated in each of FIG. 22 to FIG. 24.

Not only the performance of the radar device 43 but also other restrictions are required to be taken into consideration for the pull-over path and the vehicle speed plan. Examples of the other restrictions include physical restrictions, restrictions imposed by road signs, restrictions relating to ride comfort, restrictions regarding a positional relationship with the peripheral structures 81, and restrictions regarding a positional relationship with another vehicle in the periphery. The physical restrictions include the vehicle speed V_{self}, the acceleration and deceleration, and the steering angle. The pull-over path determiner 71 determines the pull-over path and the vehicle speed plan in consideration of the performance of the radar device 43 within a range that does not depart from those other restrictions.

As methods of using the separable lateral position table, the following two examples are conceivable. In a first example, the pull-over path determiner 71 uses the separable lateral position table when determining the pull-over path and the vehicle speed, and calculates the path and the vehicle speed in consideration of the performance of the radar device 43. In a second example, the pull-over path determiner 71 determines the path and the vehicle speed without considering the performance of the radar device 43, and examines whether or not the determined path and vehicle speed fall within a range of values in the separable lateral position table. Then, the pull-over path determiner 71 reviews portions of the path and the vehicle speed that do not fall within the range of the separable lateral position table.

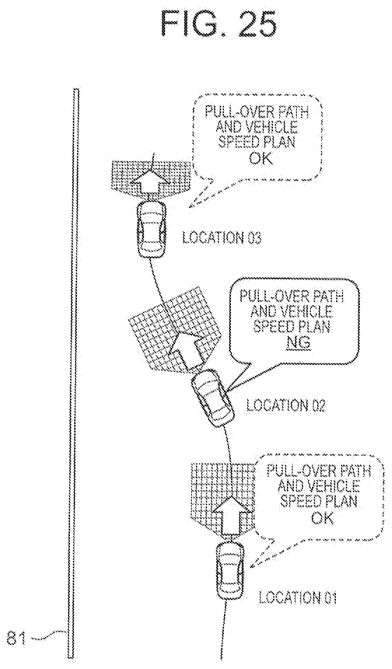

The second example is described below in detail with reference to the accompanying drawings. FIG. 25 is a view for illustrating an example of how to review the pull-over path and how to review the vehicle speed plan at a time of initial path generation in the case in which the peripheral structure 81 is linearly arranged. The pull-over path determiner 71 calculates the pull-over path and the vehicle speed plan without considering the limiting values calculated by the vehicle motion limiter 72 in advance.

In this case, an automatic driving vehicle is present in the travelable area at a location 01 and a location 03. Meanwhile, the automatic driving vehicle is supposed to travel in a non-travelable area at a location 02. The automatic driving vehicle is a vehicle 10 that automatically travels in accordance with the pull-over path and the vehicle speed plan that have been calculated.

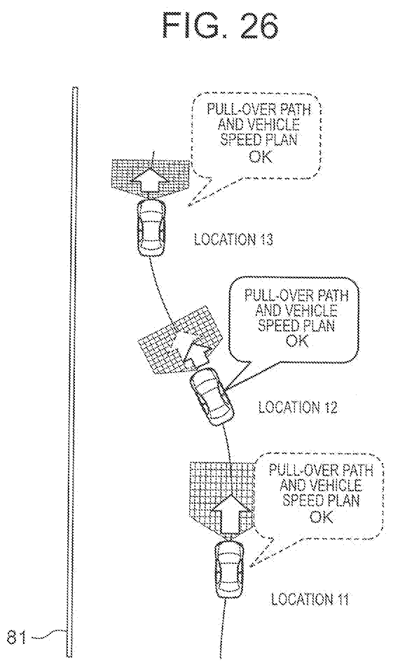

FIG. 26 is a view for illustrating an example of how to review the pull-over path and how to review the vehicle speed plan in a first path review plan when the peripheral structure 81 is linearly arranged. The vehicle motion limiter 72 examines whether or not it is possible to separately detect the peripheral structure 81 and an object in the control target monitoring area 83 when the automatic driving vehicle travels based on a path plan and a vehicle speed plan at the time of initial path generation. The pull-over path determiner 71 refers to the generated separable lateral position table to correct the path plan and vehicle speed plan for the location 02 of FIG. 25.

At that time, the vehicle motion limiter 72 sets the vehicle speed lower than the vehicle speed determined by the pull-over path determiner 71 to cause the control target monitoring area 83 to become smaller without changing the pull-over path of the automatic driving vehicle at a location 12. This enables the automatic driving vehicle to travel in the travelable area.

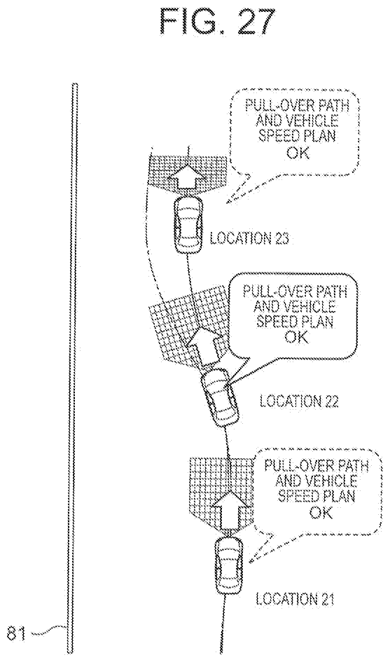

FIG. 27 is a view for illustrating an example of how to review the pull-over path and how to review the vehicle speed plan in a second path review plan when the peripheral structure 81 is linearly arranged. As illustrated in FIG. 27, the subsequent pull-over path of the automatic driving vehicle at a location 22 is indicated by the one-dot chain line. When the automatic driving vehicle travels along the pull-over path indicated by the one-dot chain line, the radar device 43 cannot separately detect the peripheral structure 81 and the object in the control target monitoring area 83.

In view of this, the vehicle motion limiter 72 sets the azimuth angle θ_{self} of the automatic driving vehicle smaller than the azimuth angle θ_{self} determined by the pull-over path determiner 71 under a state in which the vehicle speed V_{self} at the location 22 is fixed. Thus, the pull-over path subsequent to the location 22 is the pull-over path indicated by the solid line, and the automatic driving vehicle is supposed to head for a location 23. When the automatic driving vehicle travels along the pull-over path indicated by the solid line, the radar device 43 can separately detect the peripheral structure 81 and the object in the control target monitoring area 83.

In this manner, the vehicle motion limiter 72 limits at least one of the vehicle speed V_{self} or the travel path among the parameters regarding the motion of the vehicle 10.

The vehicle motion limiter 72 may keep the vehicle 10 away from the peripheral structure 81 under a state in which the vehicle speed V_{self} at the location 02 is fixed. The vehicle motion limiter 72 may also calculate the limiting value while changing the pull-over path and the vehicle speed V_{self} in association with each other.

The above description has been made on the assumption that the pull-over path determiner 71 creates the pull-over path and the vehicle speed plan before the vehicle 10 is pulled over, but the pull-over path and the vehicle speed plan may be reviewed as follows. For example, while the vehicle 10 is being pulled over, the pull-over path determiner 71 may acquire the position of the peripheral structure 81 from the object detection device 40 in real time and also acquire the vehicle speed and the steering angle from the vehicle state detector 50 to review the pull-over path and the vehicle speed plan based on those pieces of information.

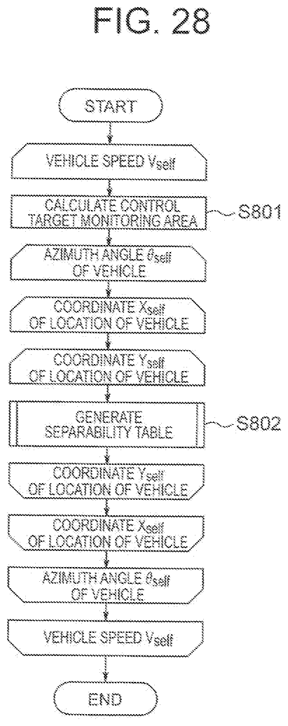

FIG. 28 is a flow chart for illustrating the pull-over-path-and-vehicle-speed-plan limiting value calculation routine in consideration of radar performance of Step S502 of FIG. 14. The routine of FIG. 28 is a routine to be executed by the vehicle motion limiter 72. The routine of FIG. 28 is a routine to be executed when the peripheral structure 81 is arranged in a random shape.

When the routine of FIG. 28 is started, in Step S801, the vehicle motion limiter 72 calculates the control target monitoring area 83. This processing step is the same as in the case in which the peripheral structure 81 is linearly arranged, and hence a detailed description thereof is omitted below.

Subsequently, in Step S802, the vehicle motion limiter 72 generates a separability table for the vehicle speed V_{self}, the azimuth angle θ_{self} of the vehicle 10, and the coordinates (X_{self}, Y_{self}) of the vehicle 10.

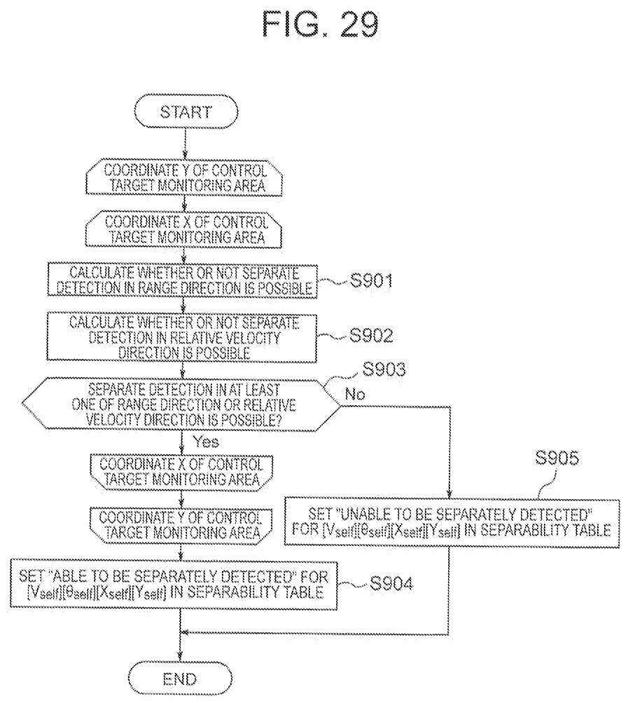

FIG. 29 is a flow chart for illustrating a separability table generation routine of Step S802 of FIG. 28. When the routine of FIG. 29 is started, the vehicle motion limiter 72 calculates in Step S901 whether or not the peripheral structure 81 and the object within the control target monitoring area 83 can be separately detected in the range direction for all points within the control target monitoring area 83. The above-mentioned calculation is performed for each vehicle speed V_{self}, each azimuth angle θ_{self} of the vehicle 10, and each set of the coordinates (X_{self}, Y_{self}) of the vehicle 10.

Subsequently, in Step S902, the vehicle motion limiter 72 calculates whether or not the peripheral structure 81 and the object within the control target monitoring area 83 can be separately detected in the relative velocity direction for all the points within the control target monitoring area 83. In Step S902, whether or not the peripheral structure 81 and the object within the control target monitoring area 83 can be separately detected in the relative velocity direction is calculated for each vehicle speed V_{self}, each azimuth angle θ_{self} of the vehicle 10, and each set of the coordinates (X_{self}, Y_{self}) of the vehicle 10.

Subsequently, in Step S903, the vehicle motion limiter 72 determines whether or not the peripheral structure 81 and the object within the control target monitoring area 83 can be separately detected in at least one of the range direction or the relative velocity direction.

When the peripheral structure 81 and the object within the control target monitoring area 83 can be separately detected in at least one of the range direction or the relative velocity direction, in Step S904, the vehicle motion limiter 72 inputs the fact of being “able to be separately detected” in a corresponding place of the separability table. The corresponding place refers to a place corresponding to each vehicle speed V_{self}, each azimuth angle θ_{self} of the vehicle 10, or each set of the coordinates (X_{self}, Y_{self}) of the vehicle 10 that has been used for the calculation.

Meanwhile, when the peripheral structure 81 and the object within the control target monitoring area 83 cannot be separately detected in the range direction or the relative velocity direction, in Step S905, the vehicle motion limiter 72 inputs the fact of being “unable to be separately detected” in the separability table.

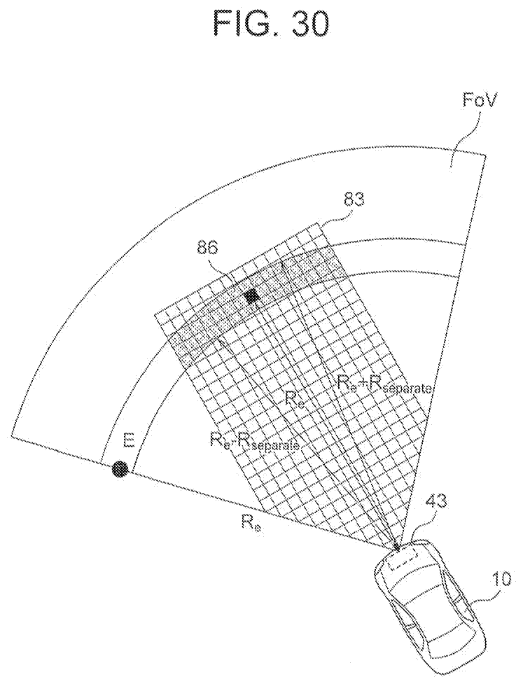

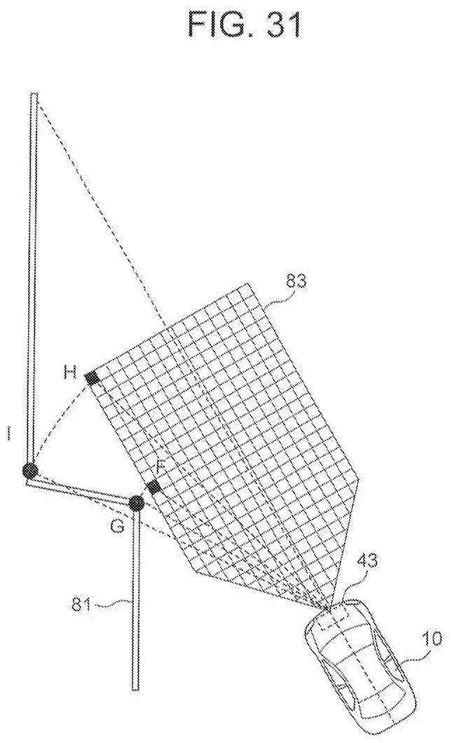

Now, the processing using the separability table is described more specifically with reference to the accompanying drawings. FIG. 30 is a view for illustrating a separability determination method for a range direction to be performed when the peripheral structure 81 is arranged in a random shape.

When a distance between a point E being a part of the peripheral structure 81 and the radar device 43 is represented by Rₑ, an object present at a point at which the distance from the radar device 43 is larger than Rₑ-Rₛₑₚₐᵣₐₜₑ and smaller than Rₑ+Rₛₑₚₐᵣₐₜₑ cannot be detected separately from an object present at the point E in the range direction. In the control target monitoring area 83, a range in which the distance from the radar device 43 is larger than Rₑ-Rₛₑₚₐᵣₐₜₑ and smaller than Rₑ+Rₛₑₚₐᵣₐₜₑ is indicated by a hatched area 86 of FIG. 30. That is, the object present within the hatched area 86 cannot be detected separately from the object present at the point E in the range direction.

In this example, the peripheral structure 81 is represented as a point, but when the peripheral structure 81 is present continuously like a wall, it is required to determine whether or not every point on the peripheral structure 81 within the FoV can be detected in the range direction separately from each point within the control target monitoring area 83. For example, when the number of points set on the peripheral structure 81 is represented by N and the number of points set within the control target monitoring area 83 is represented by M, it is determined whether or not the separate detection in the range direction is possible for N×M combinations. When the separate detection is possible for all the points within the control target monitoring area 83, the vehicle motion limiter 72 determines that the separate detection in the range direction is possible at the current vehicle speed V_{self}, azimuth angle θ_{self} of the vehicle 10, and coordinates (X_{self}, Y_{self}) of the vehicle 10.

After the vehicle motion limiter 72 determines whether or not the separate detection in the range direction is possible for all the points within the control target monitoring area 83, the vehicle motion limiter 72 generates a separability table for the range direction which defines a relationship between the vehicle speed V_{self}, azimuth angle θ_{self} of the vehicle 10, and coordinates (X_{self}, Y_{self}) of the vehicle 10 and travelability.

Next, a separability determination method for a relative velocity direction of Step S902 is described. FIG. 31 is a view for illustrating the separability determination method for the relative velocity direction to be performed when the peripheral structure 81 is arranged in a random shape. In this case, it is required to determine whether or not every point on the peripheral structure 81 within the FoV can be detected in the relative velocity direction separately from each point within the control target monitoring area 83. This is because, even when the peripheral structure 81 and the object in the control target monitoring area 83 can be separately detected in the relative velocity direction at a position far from the radar device 43, this separate detection in the relative velocity direction may be impossible at a position close to the radar device 43 depending on how the peripheral structure 81 is arranged.

As illustrated in FIG. 31, a distance between a point H at an upper left end of the control target monitoring area 83 and the radar device 43 and a distance between a point I on the peripheral structure 81 and the radar device 43 are equal to each other. In addition, a distance between a point F in the control target monitoring area 83 and the radar device 43 and a distance between a point G on the peripheral structure 81 and the radar device 43 are equal to each other. Further, a distance between the point F and the radar device 43 is shorter than a distance between the point H and the radar device 43.

Even when an object at the point H and an object at the point I can be separately detected, an object at the point F and an object at the point G may not be able to be separately detected. This is because the relative velocity difference Vₛₑₚₐᵣₐₜₑ between the point F and the point G is smaller than the relative velocity difference Vₛₑₚₐᵣₐₜₑ between the point H and the point I.

Therefore, similarly to the determination of Step S901, the vehicle motion limiter 72 computes whether or not every point on the peripheral structure 81 within the FoV can be detected in the relative velocity direction separately from each point within the control target monitoring area 83. When the separate detection is possible for all the points within the control target monitoring area 83, the vehicle motion limiter 72 determines that the separate detection in the relative velocity direction is possible at the current vehicle speed V_{self}, azimuth angle θ_{self} of the vehicle 10, and coordinates (X_{self}, Y_{self}) of the vehicle 10.

After the vehicle motion limiter 72 determines whether or not the separate detection in the relative velocity direction is possible for all the points within the control target monitoring area 83, the vehicle motion limiter 72 generates a separability table for the relative velocity direction which defines the relationship between the vehicle speed V_{self}, azimuth angle θ_{self} of the vehicle 10, and coordinates (X_{self}, Y_{self}) of the vehicle 10 and the travelability.

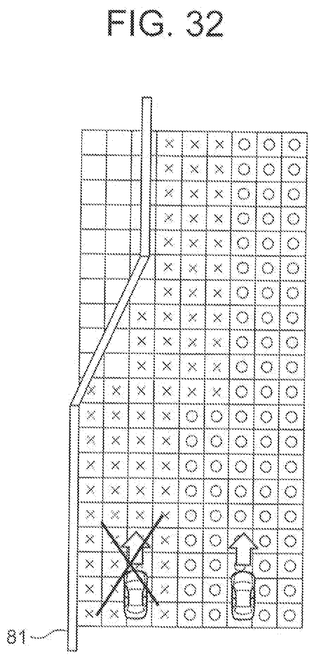

Next, the processing steps of from Step S903 to Step S905 of FIG. 29 are described in more detail with reference to the accompanying drawings. FIG. 32 is a schematic view for illustrating a first example of the travelable area of the vehicle 10 to be used when the peripheral structure 81 is arranged in a random shape. In the processing steps of from Step S903 to Step S905, in a coordinate map provided for each vehicle speed V_{self} and each azimuth angle θ_{self} of the vehicle 10, the area in which the vehicle 10 can travel is marked with “o” and the area in which the vehicle 10 cannot travel is marked with “x”.

In other words, the coordinates marked with “o” in the coordinate map of FIG. 32 are coordinates for which the fact of being “able to be separately detected” is input in Step S904. The coordinates marked with “x” in the coordinate map of FIG. 32 are coordinates for which the fact of being “unable to be separately detected” is input in Step S905.

A shape of the peripheral structure 81 illustrated in FIG. 32 is a shape that is linear but has a difference in level at some midpoint. In this case, the travelable area is set in the separability table in accordance with the shape of the peripheral structure 81.

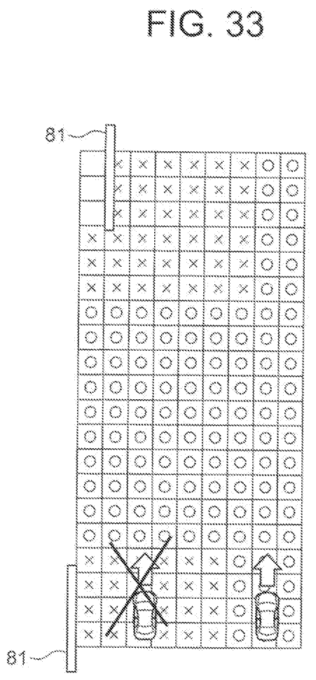

FIG. 33 is a schematic view for illustrating a second example of the travelable area of the vehicle 10 to be used when the peripheral structure 81 is arranged in a random shape. A shape of the peripheral structure 81 illustrated in FIG. 33 is a shape that is linear but has a discontinuous part at some midpoint. In this case, in the separability table, a periphery of the discontinuous part of the peripheral structure 81 is set as the travelable area.

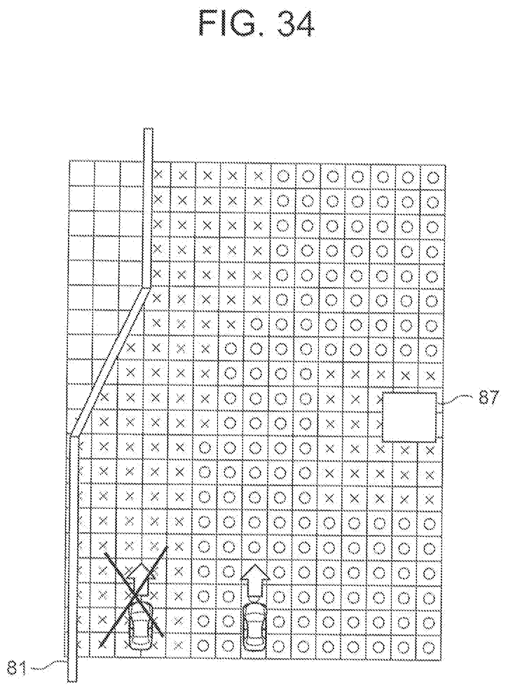

FIG. 34 is a schematic view for illustrating a third example of the travelable area of the vehicle 10 to be used when the peripheral structure 81 is arranged in a random shape. In FIG. 34, another peripheral structure 87 different from the linearly arranged peripheral structure 81 is arranged. In this case, in the separability table, a periphery of the another peripheral structure 87 is set as the non-travelable area.

In the first embodiment, detectability in each of the range direction and the relative velocity direction is determined for each predetermined vehicle speed V_{self}, each predetermined azimuth angle θ_{self} of the vehicle 10, and each predetermined set of the coordinates (X_{self}, Y_{self}) of the vehicle 10. However, in order to shorten a computation time, the detectability in each of the range direction and the relative velocity direction may be determined by limiting a computation range to assumed vehicle speeds V_{self}, assumed azimuth angles θ_{self} of the vehicle 10, and assumed coordinates (X_{self}, Y_{self}) of the vehicle 10.

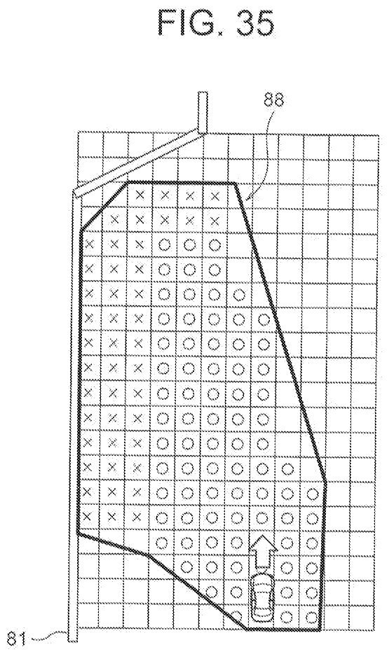

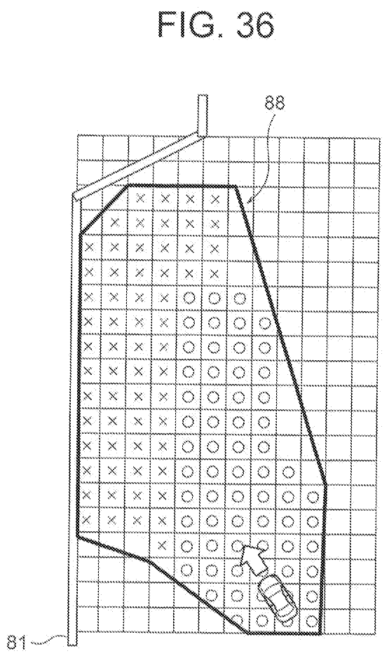

FIG. 35 is a schematic view for illustrating an example of a traveling area of the vehicle 10 to be used when the vehicle 10 travels straight in a case in which the traveling area is limited when the peripheral structure 81 is arranged in a random shape. FIG. 36 is a schematic view for illustrating an example of the traveling area of the vehicle 10 to be used when the vehicle 10 travels while approaching the peripheral structure 81 in the case in which the traveling area is limited when the peripheral structure 81 is arranged in a random shape.

As illustrated in FIG. 35 and FIG. 36, a traveling area 88 of the vehicle 10 is set, to thereby limit a range of the coordinates (X_{self}, Y_{self}) of the vehicle 10 for creating a separability table. A range of the travel area 88 of FIG. 35 and a range of the travel area 88 of FIG. 36 are the same. The travelable area is wider when the vehicle 10 travels straight than when the vehicle 10 travels while approaching the peripheral structure 81.

In the first embodiment, a table regarding the travelable area 85 of the vehicle 10 is generated for each vehicle speed V_{self} and each azimuth angle θ_{self} of the vehicle 10, but the table regarding the travelable area 85 of the vehicle 10 may be generated for each set of the coordinates (X_{self}, Y_{self}) of the vehicle 10 and each vehicle speed V_{self}. Further, the table regarding the travelable area 85 of the vehicle 10 may be generated for each set of the coordinates (X_{self}, Y_{self}) of the vehicle 10 and each azimuth angle θ_{self} of the vehicle 10.

That is, the vehicle motion limiter 72 may calculate at least one of a first limiting value, a second limiting value, or a third limiting value, and the vehicle controller 60 may control the motion of the vehicle 10 within a limit range which is based on at least one of the first limiting value, the second limiting value, or the third limiting value.

The first limiting value is a limiting value of the azimuth angle θ_{self} of the vehicle 10 to be used when the coordinates (X_{self}, Y_{self}) of the vehicle 10 and the vehicle speed V_{self} are fixed. The second limiting value is a limiting value of the coordinates (X_{self}, Y_{self}) of the vehicle 10 to be used when the vehicle speed V_{self} and the azimuth angle θ_{self} of the vehicle 10 are fixed. The third limiting value is a limiting value of the vehicle speed V_{self} to be used when the coordinates (X_{self}, Y_{self}) of the vehicle 10 and the azimuth angle θ_{self} of the vehicle 10 are fixed.

### Second Embodiment

In the first embodiment described above, the vehicle motion limiter 72 performs the calculation of the limiting value of the pull-over path and the calculation of the limiting value of the vehicle speed plan so as to allow the radar device 43 to separately detect the object assumed to be present within the control target monitoring area 83 and the peripheral structure 81. In contrast, in a second embodiment of this disclosure, the calculation of the limiting value of the pull-over path and the calculation of the limiting value of the vehicle speed plan are performed so as to allow the radar device 43 to separately detect a direct wave from the object assumed to be present within the control target monitoring area 83 and an indirect wave from the object via the peripheral structure 81. The indirect wave is a detected object that is different from the direct wave from an object assumed to be present in the control target monitoring area.

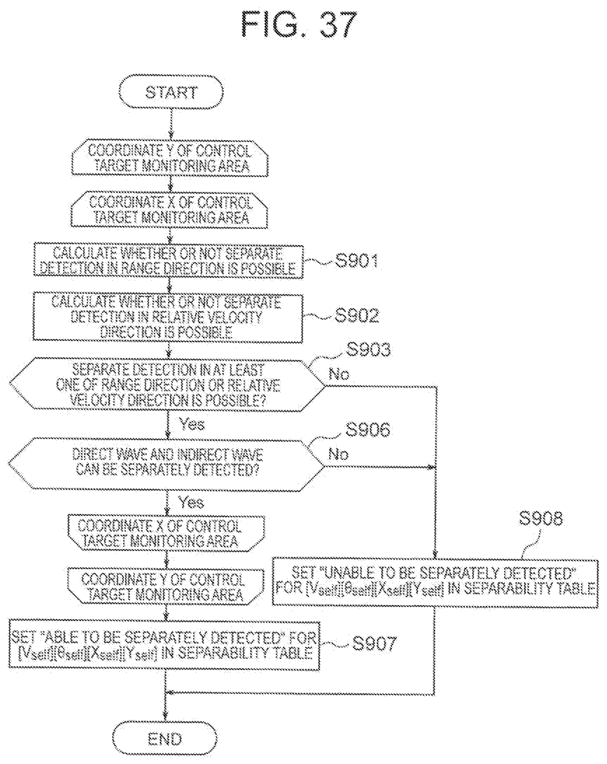

Processing steps to be executed by the roadside pull-over controller 70 are the same as the processing steps of the first embodiment up to the processing step of Step S801 in the pull-over-path-and-vehicle-speed-plan limiting value calculation routine in consideration of the radar performance which is illustrated in FIG. 28, and hence description thereof is omitted. FIG. 37 is a flow chart for illustrating a separability table generation routine in the second embodiment.

In FIG. 37, the processing steps are the same as those of the first embodiment up to the processing step of Step S903 of determining whether or not the peripheral structure 81 and the object within the control target monitoring area 83 can be separately detected in at least one of the range direction or the relative velocity direction, and hence description thereof is omitted.

When it is determined in Step S903 that the peripheral structure 81 and the object within the control target monitoring area 83 can be separately detected in at least one of the range direction or the relative velocity direction, the vehicle motion limiter 72 determines in Step S906 whether or not the direct wave from the object within the control target monitoring area 83 and the indirect wave from the object via the peripheral structure 81 can be separately detected for all the points within the control target monitoring area 83. The above-mentioned calculation is performed for each vehicle speed V_{self}, each azimuth angle θ_{self} of the vehicle 10, and each set of the coordinates (X_{self}, Y_{self}) of the vehicle 10.

When the direct wave from the object within the control target monitoring area 83 and the indirect wave from the object via the peripheral structure 81 can be separately detected, in Step S907, the vehicle motion limiter 72 inputs the fact of being “able to be separately detected” in the corresponding place of the separability table. The corresponding place refers to a place corresponding to each vehicle speed V_{self}, each azimuth angle θ_{self} of the vehicle 10, or each set of the coordinates (X_{self}, Y_{self}) of the vehicle 10 that has been used for the calculation.

When it is determined in Step S903 that the peripheral structure 81 and the object within the control target monitoring area 83 cannot be separately detected in the range direction or the relative velocity direction, in Step S908, the vehicle motion limiter 72 inputs the fact of being “unable to be separately detected” in the separability table. Further, when it is determined in Step S906 that the direct wave from the object within the control target monitoring area 83 and the indirect wave from the object via the peripheral structure 81 cannot be separately detected, in Step S908, the vehicle motion limiter 72 inputs the fact of being “unable to be separately detected” in the separability table.

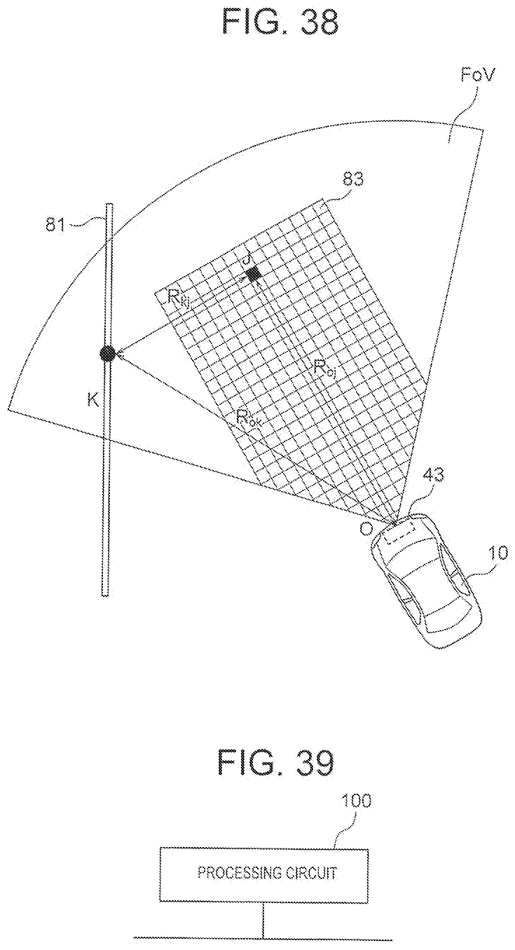

Now, a method of determining in Step S906 whether or not the direct wave from the object within the control target monitoring area 83 and the indirect wave from the object via the peripheral structure 81 can be separately detected is described more specifically with reference to the accompanying drawings. FIG. 38 is a view for illustrating a determination method for separability between a direct wave and an indirect wave to be performed when the peripheral structure 81 is arranged in a random shape.

When a point within the control target monitoring area 83 is represented by J, a center point of the radar device 43 is represented by O, and a point being a part of the peripheral structure 81 is represented by K, a transmission wave transmitted from the radar device 43 is reflected at the point J and received by the radar device 43, that is, received as a direct wave. Meanwhile, the transmission wave transmitted from the radar device 43 is reflected at the point K, and a reflected wave thereof may be further reflected at the point J and received by the radar device 43, that is, received as an indirect wave.

In this case, a distance between the point O and the point J is represented by Rₒⱼ, a distance between the point O and the point K is represented by Rₒₖ, and a distance between the point K and the point J is represented by Rₖⱼ. Further, a path of a radio wave obtained when the transmission wave transmitted from the radar device 43 is reflected at the point J and received by the radar device 43, that is, a path of the direct wave is set as a path 01, and a path of a radio wave obtained when the transmission wave transmitted from the radar device 43 reflected at the point K and the reflected wave thereof is further reflected at the point J and received by the radar device 43, that is, a path of the indirect wave is set as a path 02. At this time, the reflected wave on the path 01, that is, the direct wave is received by the radar device 43 at the distance Rₒⱼ, and the reflected wave on the path 02, that is, the indirect wave is received by the radar device 43 at a distance (Rₒₖ+Rₖⱼ+Rₒⱼ)/2.

Therefore, when a difference between the distance Rₒⱼ of the reflected wave on the path 01, that is, of the direct wave and the distance (Rₒₖ+Rₖⱼ+Rₒⱼ)/2 of the reflected wave on the path 02, that is, of the indirect wave is larger than the range difference Rₛₑₚₐᵣₐₜₑ for enabling separate detection by the radar device 43, the direct wave and the indirect wave can be separately detected in the range direction.

As the vehicle 10 becomes farther from the peripheral structure 81, the difference between the distance Rₒⱼ of the reflected wave on the path 01, that is, of the direct wave and the distance (Rₒₖ+Rₖⱼ+Rₒⱼ)/2 of the reflected wave on the path 02, that is, of the indirect wave becomes larger, and hence the separate detection in the range direction becomes easier.

In this example, only one freely-selected point on the peripheral structure 81 is considered as the detected object, but when the peripheral structure 81 is present continuously like a wall illustrated in FIG. 38, it is required to determine whether or not every point on the peripheral structure 81 within the FoV can be detected in the range direction separately from each point within the control target monitoring area 83. For example, when the number of points set on the peripheral structure 81 is represented by N and the number of points set within the control target monitoring area 83 is represented by M, it is determined whether or not the separate detection in the range direction is possible for N×M combinations.

Further, when the peripheral structure is linearly arranged, in the same manner as in the first embodiment, a lateral position at which the direct wave from the object within the control target monitoring area 83 and the indirect wave from the object via the peripheral structure 81 can be separately detected can be calculated for each vehicle speed V_{self} and each azimuth angle θ_{self} of the vehicle 10. At that time, instead of determining whether or not every point on the peripheral structure 81 within the FoV can be detected in the range direction separately from each point within the control target monitoring area 83, it is also conceivable to perform the calculation through selection of a point on the peripheral structure which is greatly influenced by the indirect wave.

After the vehicle motion limiter 72 determines whether or not the separate detection in the range direction is possible for all the points within the control target monitoring area 83, the vehicle motion limiter 72 generates a separability table for the direct wave and the indirect wave which defines the relationship between the vehicle speed V_{self}, azimuth angle θ_{self} of the vehicle 10, and coordinates (X_{self}, Y_{self}) of the vehicle 10 and the travelability.

In this example, an exemplary case of determining whether or not the separate detection in the range direction is performed has been described, but it may be determined whether or not the separate detection in the relative velocity direction is performed, and when the separate detection in at least one of the directions has been performed, the fact of being “able to be separately detected” may be input in the separability table.

In this example, the path of the indirect wave is set as “radar device 43→point on the peripheral structure 81→point within the control target monitoring area 83→radar device 43,” but another path may be conceivable in the same manner.

In this example, an exemplary case in which, from Step S901 to Step S903, it is calculated whether or not the peripheral structure 81 and the object within the control target monitoring area 83 can be separately detected in the range direction and the relative velocity direction, and when it is determined that the separate detection in at least one of the range direction or the relative velocity direction is possible, it is calculated in Step S906 whether or not the direct wave from the object within the control target monitoring area 83 and the indirect wave from the object via the peripheral structure 81 can be separately detected has been described. However, the processing step of Step S906 may be performed without executing the processing steps of from Step S901 to Step S903.

The processing steps after Step S907 and Step S908, that is, the processing steps of Step S505 and the subsequent steps are the same as those of the first embodiment, and hence description thereof is omitted.

As described above, the automatic driving device 20 according to each of the first embodiment and the second embodiment includes the vehicle controller 60. The vehicle controller 60 controls the driving of the vehicle 10 based on the information received from the radar device 43. The radar device 43 is mounted to the vehicle 10.

The driving modes of the vehicle 10 to be used by the vehicle controller 60 include the separation mode. The control target monitoring area 83 is set for the vehicle controller 60. The control target monitoring area 83 is the area on the front side in the traveling direction of the vehicle 10.

In the separation mode, the vehicle controller 60 in the first embodiment controls the driving of the vehicle 10 so that the object assumed to be present in the control target monitoring area 83 and the peripheral structure 81 are separately detected by the radar device 43. The peripheral structure 81 is the structure outside the vehicle 10.

It becomes easier for the radar device 43 to separately detect the peripheral structure 81 and the object as the vehicle 10 becomes farther from the peripheral structure 81, the vehicle speed V_{self} becomes lower, and the azimuth angle θ_{self} of the vehicle 10 becomes smaller. Therefore, in the separation mode, the driving of the vehicle 10 is controlled so that it becomes easier for the radar device 43 to separately detect the peripheral structure 81 and the object. As a result, it is possible to suppress a decrease in accuracy of object detection by the radar device 43.

In the separation mode, the vehicle controller 60 in the second embodiment controls the driving of the vehicle 10 so that the direct wave from the object assumed to be present in the control target monitoring area 83 and the indirect wave from the object via the peripheral structure 81 are separately detected by the radar device 43. The peripheral structure 81 is the structure outside the vehicle 10.

It becomes easier for the radar device 43 to separately detect the direct wave and the indirect wave as the vehicle 10 becomes farther from the peripheral structure 81. Therefore, in the separation mode, the driving of the vehicle 10 is controlled so that it becomes easier for the radar device 43 to separately detect the direct wave and the indirect wave. As a result, it is possible to suppress a decrease in accuracy of object detection by the radar device 43.

The vehicle controller 60 in each of the first embodiment and the second embodiment includes the vehicle motion limiter 72. The vehicle motion limiter 72 limits the motion of the vehicle 10 based on the resolution of the radar device 43, the coordinates (X_{self}, Y_{self}) of the vehicle 10, the vehicle speed V_{self}, and the azimuth angle θ_{self} of the vehicle 10.

With this configuration, the motion of the vehicle 10 is limited so that it becomes easier to separately detect the peripheral structure 81 and the object in the range direction or the relative velocity direction of the radar device 43. In addition, the motion of the vehicle 10 is limited so that it becomes easier to separately detect the direct wave from the object and the indirect wave from the object via the peripheral structure 81 in the range direction or the relative velocity direction of the radar device 43. This enables the radar device 43 to detect the object with higher reliability without increasing the resolution of the radar device 43.

In addition, the vehicle motion limiter 72 limits at least one of the vehicle speed V_{self} or the travel path of the vehicle 10 among the parameters regarding the motion of the vehicle 10.

For example, as the vehicle speed V_{self} is set lower, a distance to be traveled until the vehicle is stopped by braking becomes shorter, and hence the length Lₓ of the control target monitoring area 83 can be shortened. Further, as the vehicle speed V_{self} is set higher, it becomes easier to separately detect the peripheral structure 81 and the target object 82 in the relative velocity direction. Further, as the azimuth angle of the vehicle 10 with respect to the peripheral structure 81 becomes gentler, it becomes easier to separately detect the peripheral structure 81 and the target object 82 in the relative velocity direction. Further, as the distance between the peripheral structure 81 and the vehicle 10 becomes longer, it becomes easier to separately detect the peripheral structure 81 and the target object 82 in the range direction. As a result, limitation on the motion of the vehicle 10 can be mitigated. That is, when at least one of the vehicle speed V_{self} or the path is limited, it becomes easier to separately detect the peripheral structure 81 and the target object 82 in at least one direction of the range direction or the relative velocity direction. Further, as the vehicle 10 becomes farther from the peripheral structure 81, it becomes easier for the radar device 43 to separately detect the direct wave from the target object 82 and the indirect wave from the object via the peripheral structure 81. As a result, the limitation on the motion of the vehicle 10 can be mitigated.

Further, the radar device 43 has the plurality of control modes relating to the range resolution. The plurality of control modes include the manual driving compatible mode and the automatic driving compatible mode. The automatic driving compatible mode is the mode to be selected when the driving entity of the vehicle 10 is the vehicle controller 60. The first range resolution is higher than the second range resolution. The first range resolution is the range resolution in the automatic driving compatible mode. The second range resolution is the range resolution in the manual driving compatible mode.

In the automatic driving compatible mode, the vehicle controller 60 executes control for automatically stopping the vehicle 10 on the roadside.

Higher object detection reliability is required when the driving entity is a vehicle controller than when the driving entity is a driver. Therefore, when the driving entity is the vehicle controller 60, the control mode of the radar device 43 is switched to a higher-resolution mode. Thus, it is possible to expand an area in which the peripheral structure 81 and the target object 82 can be separately detected by the radar device 43 and an area in which the direct wave from the target object 82 and the indirect wave from the target object 82 via the peripheral structure 81 can be separately detected by the radar device 43. Under a state in which the area in which the peripheral structure 81 and the target object 82 can be separately detected by the radar device 43 and the area in which the direct wave from the target object 82 and the indirect wave from the target object 82 via the peripheral structure 81 can be separately detected by the radar device 43 have been expanded, the vehicle 10 is automatically stopped on the roadside. As a result, it is possible to stop the vehicle 10 on the roadside more safely.

Further, the radar device 43 has the plurality of control modes relating to the relative velocity resolution. The plurality of control modes include the manual driving compatible mode and the automatic driving compatible mode. The automatic driving compatible mode is the mode to be selected when the driving entity of the vehicle 10 is the vehicle controller 60. The first relative velocity resolution is higher than the second relative velocity resolution. The first relative velocity resolution is the relative velocity resolution in the automatic driving compatible mode. The second relative velocity resolution is the relative velocity resolution in the manual driving compatible mode.

In the automatic driving compatible mode, the vehicle controller 60 executes control for automatically stopping the vehicle 10 on the roadside.

With this configuration, when the driving entity is the vehicle controller 60, the control mode of the radar device 43 is switched to the higher-resolution mode. Thus, it is possible to expand the area in which the peripheral structure 81 and the target object 82 can be separately detected by the radar device 43 and the area in which the direct wave from the target object 82 and the indirect wave from the target object 82 via the peripheral structure 81 can be separately detected by the radar device 43. Under the state in which the area in which the peripheral structure 81 and the target object 82 can be separately detected by the radar device 43 and the area in which the direct wave from the target object 82 and the indirect wave from the target object 82 via the peripheral structure 81 can be separately detected by the radar device 43 have been expanded, the vehicle 10 is automatically stopped on the roadside. As a result, it is possible to stop the vehicle 10 on the roadside more safely.

Further, the radar device 43 has the plurality of control modes relating to the range resolution and the relative velocity resolution. The vehicle controller 60 selects, from among the plurality of control modes, a control mode in which at least one of the range resolution or the relative velocity resolution is set higher as the vehicle speed V_{self} becomes lower.

With this configuration, by narrowing down the detection range and increasing at least one of the range resolution or the relative velocity resolution as the vehicle speed V_{self} becomes lower, it is possible to operate the radar device 43 in the higher-resolution mode within ranges of a limited memory capacity and a limited computation time. Therefore, it is possible to expand the area in which the separate detection can be performed by the radar device 43. As a result, the limitation on the motion of the vehicle 10 can be further mitigated.

Further, the radar device 43 has the plurality of control modes relating to the range resolution and the relative velocity resolution. The vehicle controller 60 selects, from among the plurality of control modes, a control mode in which at least one of the range resolution or the relative velocity resolution is set higher as the distance between the vehicle 10 and the peripheral structure 81 becomes shorter.

With this configuration, as the vehicle 10 approaches the peripheral structure 81, the control mode of the radar device 43 is switched to a control mode in which at least one of the range resolution or the relative velocity resolution is set higher. Thus, it is possible to expand the area in which the peripheral structure 81 and the target object 82 can be separately detected by the radar device 43 and the area in which the direct wave from the target object 82 and the indirect wave from the target object 82 via the peripheral structure 81 can be separately detected by the radar device 43. As a result, the limitation on the motion of the vehicle 10 can be further mitigated.

Further, the vehicle motion limiter 72 determines whether or not the peripheral structure 81 and the object or the direct wave from the object and the indirect wave from the object via the peripheral structure 81 are separately detected by the radar device 43 in at least one direction of the range direction or the relative velocity direction at the coordinates (X_{self}, Y_{self}) of the vehicle 10, the azimuth angle θ_{self} of the vehicle 10, and the vehicle speed V_{self} on a travelable path of the vehicle 10.

The vehicle motion limiter 72 calculates at least one of the limiting value of the azimuth angle θ_{self} of the vehicle 10 to be used when the coordinates (X_{self}, Y_{self}) of the vehicle 10 and the vehicle speed V_{self} are fixed, the limiting value of the coordinates (X_{self}, Y_{self}) of the vehicle 10 to be used when the vehicle speed V_{self} and the azimuth angle θ_{self} of the vehicle 10 are fixed, and the limiting value of the vehicle speed V_{self} to be used when the coordinates (X_{self}, Y_{self}) of the vehicle and the azimuth angle θ_{self} of the vehicle 10 are fixed.

The vehicle controller 60 controls the motion of the vehicle 10 within a limit range which is based on the calculated at least one of the limiting value of the azimuth angle θ_{self} of the vehicle 10, the limiting value of the coordinates (X_{self}, Y_{self}) of the vehicle 10, or the limiting value of the vehicle speed V_{self}.

With this configuration, it is possible to appropriately select a table regarding parameters for limiting the motion of the vehicle 10 depending on a situation of object detection by the radar device 43. Therefore, it is possible to more easily achieve an automatic driving device with which it is easy for the radar device 43 to separately detect the peripheral structure 81 and the target object 82 and it is easy for the radar device 43 to separately detect the direct wave from the target object 82 and the indirect wave from the target object 82 via the peripheral structure 81.

Further, the radar device 43 in the present embodiments includes the radar main body 431 and the radar controller 432. The radar main body 431 is mounted to the vehicle 10. The radar controller 432 controls the radar main body 431 by the plurality of control modes relating to the range resolution.

The first range resolution is higher than the second range resolution. The first range resolution is the range resolution to be used in the automatic driving compatible mode. The second range resolution is the range resolution to be used in the manual driving compatible mode.

Higher object detection reliability is required when the driving entity is the vehicle controller 60 than when the driving entity is the driver. Therefore, when the driving entity is the vehicle controller 60, the control mode of the radar device 43 is switched to the higher-resolution mode. Thus, it is possible to expand the area in which the peripheral structure 81 and the target object 82 can be separately detected by the radar device 43 and the area in which the direct wave from the target object 82 and the indirect wave from the target object 82 via the peripheral structure 81 can be separately detected by the radar device 43. As a result, it is possible to achieve the radar device 43 with which the limitation on the motion of the vehicle 10 can be further mitigated.

Further, the radar device 43 in the present embodiments includes the radar main body 431 and the radar controller 432. The radar main body 431 is mounted to the vehicle 10. The radar controller 432 controls the radar main body 431 by the plurality of control modes relating to the relative velocity resolution.

The first relative velocity resolution is higher than the second relative velocity resolution. The first relative velocity resolution is the relative velocity resolution in the automatic driving compatible mode. The second relative velocity resolution is the relative velocity resolution in the manual driving compatible mode.

Higher object detection reliability is required when the driving entity is the vehicle controller 60 than when the driving entity is the driver. Therefore, when the driving entity is the vehicle controller 60, the control mode of the radar device 43 is switched to the higher-resolution mode. Thus, it is possible to expand the area in which the peripheral structure 81 and the target object 82 can be separately detected by the radar device 43 and the area in which the direct wave from the target object 82 and the indirect wave from the target object 82 via the peripheral structure 81 can be separately detected by the radar device 43. As a result, it is possible to achieve the radar device 43 with which the limitation on the motion of the vehicle 10 can be further mitigated.

Further, the radar device 43 in the present embodiments includes the radar main body 431 and the radar controller 432. The radar main body 431 is mounted to the vehicle 10. The radar controller 432 sets at least one of the range resolution or the relative velocity resolution higher as the vehicle speed V_{self} becomes lower.

With this configuration, by narrowing down the detection range and increasing at least one of the range resolution or the relative velocity resolution as the vehicle speed V_{self} becomes lower, it is possible to operate the radar device 43 in the higher-resolution mode within ranges of a limited memory capacity and a limited computation time. As a result, it is possible to achieve the radar device 43 with which the limitation on the motion of the vehicle 10 can be further mitigated.

Further, the radar device 43 in the present embodiments includes the radar main body 431 and the radar controller 432. The radar main body 431 is mounted to the vehicle 10. The radar controller 432 sets at least one of the range resolution or the relative velocity resolution higher as the distance between the vehicle 10 and the peripheral structure 81 becomes shorter.

With this configuration, as the vehicle 10 approaches the peripheral structure 81, the control mode of the radar device 43 is switched to a control mode in which at least one of the range resolution or the relative velocity resolution is set higher. Thus, it is possible to expand the area in which the peripheral structure 81 and the target object 82 can be separately detected by the radar device 43 and the area in which the direct wave from the target object 82 and the indirect wave from the target object 82 via the peripheral structure 81 can be separately detected by the radar device 43. As a result, it is possible to achieve the radar device 43 with which the limitation on the motion of the vehicle 10 can be further mitigated.

Further, in the radar device 43 in each of the first embodiment and the second embodiment, the frequency modulation width B in the automatic driving compatible mode is wider than the frequency modulation width B in the manual driving compatible mode.

With this configuration, in the automatic driving compatible mode, it is possible to expand the area in which the peripheral structure 81 and the target object 82 can be separately detected by the radar device 43 and the area in which the direct wave from the target object 82 and the indirect wave from the target object 82 via the peripheral structure 81 can be separately detected by the radar device 43. As a result, it is possible to achieve the radar device 43 with which the limitation on the motion of the vehicle 10 can be further mitigated.

Further, in the radar device 43 in each of the first embodiment and the second embodiment, the chirp sequence time T_{cs} in the automatic driving compatible mode is longer than the chirp sequence time T_{cs} in the manual driving compatible mode.

With this configuration, in the automatic driving compatible mode, it is possible to expand the area in which the peripheral structure 81 and the target object 82 can be separately detected by the radar device 43 and the area in which the direct wave from the target object 82 and the indirect wave from the target object 82 via the peripheral structure 81 can be separately detected by the radar device 43. As a result, it is possible to achieve the radar device 43 with which the limitation on the motion of the vehicle 10 can be further mitigated.

Further, in the radar device 43 in each of the first embodiment and the second embodiment, a processing cycle period of modulation in the automatic driving compatible mode is longer than a processing cycle period of modulation in the manual driving compatible mode.

With this configuration, in the automatic driving compatible mode, it is possible to expand the area in which the peripheral structure 81 and the target object 82 can be separately detected by the radar device 43 and the area in which the direct wave from the target object 82 and the indirect wave from the target object 82 via the peripheral structure 81 can be separately detected by the radar device 43. As a result, it is possible to achieve the radar device 43 with which the limitation on the motion of the vehicle 10 can be further mitigated.

In the first embodiment and the second embodiment, as the FCM method, the frequency of the carrier wave is repeatedly caused to drop at a constant rate of change, but the frequency of the carrier wave may be repeatedly raised. The number N_{chirp} of chirps, the rate of change of the frequency, and the frequency modulation width B are not particularly limited by the above-mentioned examples. In addition, the modulation method of the radar device 43 may not be the FCM method. For example, a frequency modulated continuous wave (FM-CW) method or a pulse Doppler method may be employed.

Further, a part or all of the functions of the radar controller 432 may be incorporated in the vehicle controller 60.

Further, as the method of extracting the peak in Step S102, for example, a method of extracting such a frequency bin as to exceed a threshold set in advance and have a local maximum value from among frequency bins may be employed. In addition, data on reception channels may be added up at a previous stage of the peak detection. For example, the peak may be extracted after adding up and averaging amplitude values corresponding to four channels. Further, the peak may be extracted after directing the beam toward a direction set in advance by a publicly known digital beam forming (DBF) processing.

Further, the method of calculating the distance from the target object and the relative velocity with respect to the target object in Step S103 is not particularly limited to the FCM method.

Further, as the method of measuring the azimuth angle in Step S104, a super-resolution angle measurement method may be used, a maximum likelihood estimation method may be used, or another method may be used.

Further, in the first embodiment and the second embodiment, after it is determined that the pull-over area can be entered and the vehicle 10 is decelerated to the second vehicle speed, the control mode of the radar device 43 is changed from the manual driving compatible mode to the automatic driving compatible mode, but the method of shifting the mode is not limited thereto.

For example, the shift to the automatic driving compatible mode may be performed after the driver falls into a situation in which the driver has difficulty in driving. The shift to the automatic driving compatible mode may also be performed at any timing from start to end of a series of pull-over control. The series of pull-over control refers to such control as to cause the vehicle 10 to travel in the same lane at a constant speed for a while after the driver falls into a situation in which the driver has difficulty in driving, then decelerate the vehicle 10 at a time point at which an area that enables pull-over thereto is found, and stop the vehicle 10 on the roadside.

Further, the roadside pull-over controller 70 may change the range resolution of the radar device 43 stepwise in accordance with the vehicle speed, or may change the relative velocity resolution of the radar device 43 stepwise in accordance with the vehicle speed. The roadside pull-over controller 70 may also change the range resolution of the radar device 43 stepwise in accordance with the distance from the peripheral structure 81, or may change the relative velocity resolution of the radar device 43 stepwise in accordance with the distance from the peripheral structure 81.

Further, the roadside pull-over controller 70 may set the control target monitoring area in accordance with a behavior of an application to be controlled, and select the control mode of the radar device 43 so that the control target monitoring area is covered.

Further, the distance range and the relative velocity range to be observed are desired to be maintained with the range resolution and the relative velocity resolution having been set high, but to this end, it is required to increase the number Nₛₐₘₚₗₑ of samples per chirp and the number N_{chirp} of chirps. This adversely increases a memory size of the radar controller 432. As a countermeasure against this, the distance range and the relative velocity range are desired to be limited in accordance with the vehicle speed.

Further, in the first embodiment and the second embodiment, the vehicle motion limiter 72 calculates the control target monitoring area 83, but the driving support controller 61 may calculate the control target monitoring area 83 and output a result of the calculation to the vehicle motion limiter 72.

Further, in the first embodiment and the second embodiment, the lateral position is calculated in real time for each vehicle speed V_{self} and each azimuth angle θ_{self} of the vehicle 10, but when several travel patterns for pulling over to the roadside are defined, the lateral position may be calculated in the following manner. For example, there may be provided such a table of the lateral position limiting values as to be used for limiting in advance the motion of the vehicle 10 by the travel pattern so that the object within the control target monitoring area 83 can be detected separately from the peripheral structure 81 in at least one direction of the range direction or the relative velocity direction. There may be also provided such a table of the lateral position limiting values as to be used for limiting in advance the motion of the vehicle 10 by the travel pattern so that the direct wave from the object within the control target monitoring area 83 can be detected separately from the indirect wave from the object via the peripheral structure 81 in at least one direction of the range direction or the relative velocity direction.

In such a case, even when the peripheral structure 81 is not actually present, the table may be created so that the object within the control target monitoring area 83 can be detected separately from the virtual structure being a virtual peripheral structure 81 in at least one direction of the range direction or the relative velocity direction. In addition, the table may be created so that the direct wave from the object within the control target monitoring area 83 can be detected separately from the indirect wave from the object via the virtual structure in at least one direction of the range direction or the relative velocity direction. When the virtual structure is assumed as the structure in this manner, it is possible to limit in advance the motion of the vehicle 10 by the travel pattern so as to enable the separate detection in at least one direction of the range direction or the relative velocity direction with a small amount of computation resources without calculating the lateral position in real time.

Further, in the examples illustrated in FIG. 30, FIG. 31, and FIG. 38, it is determined whether or not the separate detection in at least one direction of the range direction or the relative velocity direction is possible for all the points in the control target monitoring area 83, but when a state in which the separate detection is impossible is partially allowed, it is not required to perform the determination for all points. For example, when the peripheral structure 81 and the object within the control target monitoring area 83 cannot be separately detected but this can be complemented by another sensor of the object detection device 40, the radar device 43 is not always required to perform the separate detection in at least one direction of the range direction or the relative velocity direction.

Further, when the separate detection was performed by the radar device 43 in the past, through interpolation of data based on the past data, it is possible to complement a partial range in which the separate detection is impossible.

Further, in the present embodiments, when it is determined whether or not the separate detection in at least one direction of the range direction or the relative velocity direction is possible, the vehicle motion limiter 72 determines whether or not every point on the peripheral structure 81 within the FoV and each point within the control target monitoring area 83 can be separately detected. However, when the shape of the peripheral structure 81 is complicated, the vehicle motion limiter 72 may approximate the shape of the peripheral structure 81 to a simpler shape.

Further, when a travel pattern for pulling over to the roadside is defined in advance, instead of the real-time update of the separability table, there is provided such a table as to be used for limiting the motion of the vehicle 10 by the travel pattern so that the object within the control target monitoring area 83 can be detected separately from the peripheral structure 81 in at least one direction of the range direction or the relative velocity direction. There may be also provided such a table as to be used for limiting the motion of the vehicle 10 by the travel pattern so that the direct wave from the object within the control target monitoring area 83 can be detected separately from the indirect wave from the object via the peripheral structure 81 in at least one direction of the range direction or the relative velocity direction.

In this case, even when the peripheral structure 81 is not actually present, the table may be created so that the object in the control target monitoring area 83 can be detected separately from the virtual structure in at least one direction of the range direction or the relative velocity direction. In addition, the table may be created so that the direct wave from the object within the control target monitoring area 83 can be detected separately from the indirect wave from the object via the virtual structure in at least one direction of the range direction or the relative velocity direction. When the virtual structure is assumed as the structure in this manner, it is possible to limit in advance the motion of the vehicle 10 by the travel pattern so as to enable the separate detection in at least one direction of the range direction or the relative velocity direction with a small amount of computation resources without calculating the separability table in real time.

Further, in the first embodiment and the second embodiment, the pull-over area is searched for based on the information received from the locator 45, but may be searched for based on the information received from the camera 42, or may be searched for through estimation of the shape of the road based on the information received from the radar device 43. In any case, any method may be used as long as it can be determined whether or not the pull-over area is present.

Further, in the first embodiment and the second embodiment, the control routines illustrated in the flow charts are each executed every 50 ms, but a repetition interval for those routines is not limited thereto. For example, each control routine may be executed every 20 ms. In short, it suffices that each control routine is executed at a cycle period suitable for controlling the vehicle 10.

Further, in the first embodiment and the second embodiment, the object assumed to be present within the control target monitoring area 83 is assumed to be a stationary object, but even when the stationary object is replaced by a moving object, it is possible to determine whether or not the peripheral structure 81 and the moving object can be separately detected. In addition, even when the stationary object is replaced by the moving object, it is possible to determine whether or not a direct wave from the moving object and an indirect wave from the moving object via the peripheral structure 81 can be separately detected. It may also be assumed that the different detected object is not only the stationary object such as the peripheral structure but also a moving object such as a traveling vehicle or a pedestrian, and it is possible to determine whether or not the object within the control target monitoring area 83 and the moving object can be separately detected and to determine whether or not the direct wave from the object within the control target monitoring area 83 and the indirect wave from the object within the control target monitoring area 83 via the moving object can be separately detected.

Further, in the first embodiment and the second embodiment, it is determined whether or not the driver of the vehicle 10 is in a situation in which the driver has difficulty in driving in Step S201 of the driving mode selection routine illustrated in FIG. 11. However, for example, when this step is replaced by a step of determining whether or not the driver has issued an instruction to automatically pull over the vehicle 10 to the roadside, it is possible in the present embodiments to execute the control for automatically stopping the vehicle 10 on the roadside even when the driver of the vehicle 10 does not have difficulty in driving.

Further, in the first embodiment, the example in which the object assumed to be present within the control target monitoring area 83 and the peripheral structure 81 are separately detected in the range direction or the relative velocity direction by the radar device 43 has been described. Further, in the second embodiment, the example in which the direct wave from the object assumed to be present within the control target monitoring area 83 and the indirect wave from the object via the peripheral structure 81 are separately detected in the range direction or the relative velocity direction by the radar device 43 has been described. However, a calculation flow for separate detection in the angular direction in addition to the range direction and the relative velocity direction may be added.

Further, the functions of the automatic driving device 20 according to each of the first embodiment and the second embodiment are implemented by a processing circuit. FIG. 39 is a configuration diagram for illustrating a first example of a processing circuit that implements functions of the automatic driving device 20 according to each of the first embodiment and the second embodiment. A processing circuit 100 in the first example is dedicated hardware.

Further, the processing circuit 100 corresponds to, for example, a single circuit, a complex circuit, a programmed processor, a processor for a parallel program, an application specific integrated circuit (ASIC), a field programmable gate array (FPGA), or a combination thereof.

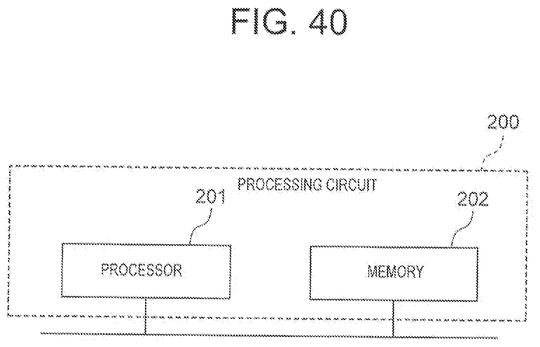

Further, FIG. 40 is a configuration diagram for illustrating a second example of the processing circuit that implements the functions of the automatic driving device 20 according to each of the first embodiment and the second embodiment. A processing circuit 200 in the second example includes a processor 201 and a memory 202.

In the processing circuit 200, the functions of the automatic driving device 20 are implemented by software, firmware, or a combination of software and firmware. The software and the firmware are described as programs to be stored in the memory 202. The processor 201 reads out and executes the programs stored in the memory 202, to thereby implement the respective functions.

The programs stored in the memory 202 can also be regarded as programs for causing a computer to execute the procedure or method of each of the above-mentioned components. In this case, the memory 202 corresponds to, for example, a nonvolatile or volatile semiconductor memory, such as a random access memory (RAM), a read only memory (ROM), a flash memory, an erasable programmable read only memory (EPROM), or an electronically erasable and programmable read only memory (EEPROM). Further, a magnetic disk, a flexible disk, an optical disc, a compact disc, a mini disc, or a DVD may also correspond to the memory 202.

The functions of the automatic driving device 20 described above may be implemented partially by dedicated hardware, and partially by software or firmware.

In this way, the processing circuit can implement the functions of the above-mentioned automatic driving device 20 by hardware, software, firmware, or a combination thereof.

What is claimed is:

1. An automatic driving device, comprising a vehicle controller configured to control driving of a vehicle based on information received from a radar device mounted to the vehicle,
wherein driving modes of the vehicle to be used by the vehicle controller include a separation mode,
wherein the vehicle controller has a control target monitoring area set therefor, the control target monitoring area being an area on a front side in a traveling direction of the vehicle,
wherein the vehicle controller is configured to control the driving of the vehicle in the separation mode so that an object assumed to be present in the control target monitoring area and a detected object that is different from the object are separately detected by the radar device, and
wherein the detected object is at least one of a structure outside the vehicle or an indirect wave from the object via the structure.

2. The automatic driving device according to claim 1, wherein the vehicle controller includes a vehicle motion limiter configured to limit motion of the vehicle based on a resolution of the radar device, coordinates of the vehicle, a speed of the vehicle, and an azimuth angle of the vehicle.

3. The automatic driving device according to claim 2, wherein the vehicle motion limiter is configured to limit at least one of the speed of the vehicle or a travel path of the vehicle among parameters regarding the motion of the vehicle.

4. The automatic driving device according to claim 1,
wherein the radar device has a plurality of control modes relating to a range resolution,
wherein the plurality of control modes include a manual driving compatible mode and an automatic driving compatible mode to be selected when a driving entity of the vehicle is the vehicle controller,
wherein a first range resolution being the range resolution to be used in the automatic driving compatible mode is higher than a second range resolution being the range resolution to be used in the manual driving compatible mode, and
wherein the vehicle controller is configured to execute, in the automatic driving compatible mode, control for automatically stopping the vehicle on a roadside.

5. The automatic driving device according to claim 1,
wherein the radar device has a plurality of control modes relating to a relative velocity resolution,
wherein the plurality of control modes include a manual driving compatible mode and an automatic driving compatible mode to be selected when a driving entity of the vehicle is the vehicle controller,
wherein a first relative velocity resolution being the relative velocity resolution to be used in the automatic driving compatible mode is higher than a second relative velocity resolution being the relative velocity resolution to be used in the manual driving compatible mode, and
wherein the vehicle controller is configured to execute, in the automatic driving compatible mode, control for automatically stopping the vehicle on a roadside.

6. The automatic driving device according to claim 1,
wherein the radar device has a plurality of control modes relating to a range resolution and a relative velocity resolution, and
wherein the vehicle controller is configured to select, from among the plurality of control modes, a control mode in which at least one of the range resolution or the relative velocity resolution is set higher as a speed of the vehicle becomes lower.

7. The automatic driving device according to claim 1,
wherein the radar device has a plurality of control modes relating to a range resolution and a relative velocity resolution, and
wherein the vehicle controller is configured to select, from among the plurality of control modes, a control mode in which at least one of the range resolution or the relative velocity resolution is set higher as a distance between the vehicle and the structure becomes shorter.

8. The automatic driving device according to claim 2,
wherein the vehicle motion limiter is configured to determine whether the detected object and the object are separately detected in at least one direction of a range direction or a relative velocity direction by the radar device at the coordinates of the vehicle, the azimuth angle of the vehicle, and the speed of the vehicle on a travelable path of the vehicle,
wherein the vehicle motion limiter is configured to calculate at least one of a limiting value of an azimuth angle of the vehicle to be used when the coordinates of the vehicle and the speed of the vehicle are fixed, a limiting value of the coordinates of the vehicle to be used when the speed of the vehicle and the azimuth angle of the vehicle are fixed, or a limiting value of the speed of the vehicle to be used when the coordinates of the vehicle and the azimuth angle of the vehicle are fixed, and
wherein the vehicle controller is configured to control the motion of the vehicle within a limit range which is based on the calculated at least one of the limiting value of the azimuth angle of the vehicle, the limiting value of the coordinates of the vehicle, or the limiting value of the speed of the vehicle.

9. A radar device which is mounted to the automatic driving device of claim 4, the radar device comprising:
a radar main body mounted to the vehicle; and
a radar controller configured to control the radar main body by the plurality of control modes relating to the range resolution,
wherein a first range resolution being the range resolution to be used in the automatic driving compatible mode is higher than a second range resolution being the range resolution to be used in the manual driving compatible mode.

10. A radar device which is mounted to the automatic driving device of claim 5, the radar device comprising:
a radar main body mounted to the vehicle; and
a radar controller configured to control the radar main body by the plurality of control modes relating to the relative velocity resolution,
wherein a first relative velocity resolution being the relative velocity resolution to be used in the automatic driving compatible mode is higher than a second relative velocity resolution being the relative velocity resolution to be used in the manual driving compatible mode.

11. A radar device which is mounted to the automatic driving device of claim 6, the radar device comprising:
a radar main body mounted to the vehicle; and
a radar controller configured to control the radar main body,
wherein the radar controller is configured to set at least one of the range resolution or the relative velocity resolution higher as the speed of the vehicle becomes lower.

12. A radar device which is mounted to the automatic driving device of claim 7, the radar device comprising:
a radar main body mounted to the vehicle; and
a radar controller configured to control the radar main body,
wherein the radar controller is configured to set at least one of the range resolution or the relative velocity resolution higher as the distance between the vehicle and the structure becomes shorter.

13. The radar device according to claim 9, wherein a frequency modulation width in the automatic driving compatible mode is wider than a frequency modulation width in the manual driving compatible mode.

14. The radar device according to claim 10, wherein a chirp sequence time in the automatic driving compatible mode is longer than a chirp sequence time in the manual driving compatible mode.

15. The radar device according to claim 10, wherein a processing cycle period of modulation in the automatic driving compatible mode is longer than a processing cycle period of modulation in the manual driving compatible mode.

16. An automatic driving device, comprising a vehicle controller configured to control driving of a vehicle based on information received from a radar device mounted to the vehicle,
wherein driving modes of the vehicle to be used by the vehicle controller include a separation mode,
wherein the vehicle controller has a control target monitoring area set therefor, the control target monitoring area being an area on a front side in a traveling direction of the vehicle, and
wherein the vehicle controller is configured to control the driving of the vehicle in the separation mode so that an object assumed to be present in the control target monitoring area and a detected object that is different from the object are separately detected by the radar device.
